(19) United States
(12) Patent Application Publication
(10) Pub. No.: US 2018/0363623 A1
(43) Pub. Date: Dec. 20, 2018

(54) WIND ENERGY SYSTEM INCLUDING CANYON STRUCTURE

(71) Applicant: STARGREEN POWER CORPORATION, Calgary (CA)

(72) Inventor: Jean Barlot, Calgary (CA)

(21) Appl. No.: 15/781,778

(22) PCT Filed: Dec. 19, 2016
(86) PCT No.: PCT/CA2016/051511

§ 371 Date: Jun. 6, 2018

Related U.S. Application Data
(60) Provisional application No. 62/269,634, filed on Dec. 18, 2015.
(60) Provisional application No. 62/296,309, filed on Feb. 17, 2016.
(60) Provisional application No. 62/427,443, filed on Nov. 29, 2016.

(51) Int. Cl. F03D 1/04; F03D 9/25; F03D 9/12; F03D 1/02; F04D 25/08; H02K 7/02; H02K 7/20; H02K 7/108; H02K 7/18

(52) U.S. Cl. CPC F03D 1/04; F03D 9/25; F03D 9/12; F03D 1/025; F04D 25/08; H02K 7/02; F05B 2260/96; H02K 7/108; H02K 7/183; F05B 2240/13; F05B 2240/91; F05B 2220/706; F05B 2270/32; H02K 7/20

(57) ABSTRACT

Large wind inlet ducts connected to one or more ducted turbines are used for conversion of wind energy into electricity. A main building structure into which are located the large inlet ducts and the turbines is supplemented by a plurality of large scale channel walls radiating outward for defining a plurality of canyon structures for accelerating wind towards the main building structure.

### FIELD OF THE INVENTION

The present invention relates to wind energy systems for conversion of wind energy into electricity for commercial distribution by using large wind funnels located within structures to accelerate wind to a turbine and generator, and more particularly the present invention relates to a wind energy system within a main building structure including a plurality of large scale channel walls radiating from the main building structure which function as a canyon for accelerating wind towards the main building structure. The present invention further relates to a wind turbine assembly having a flywheel rotating with the rotor and a booster motor which drives rotation of the turbine rotor and flywheel supplementary to the wind forces in a low wind condition. The present invention yet further relates to a wind turbine assembly having a discharge assembly which is operable in a first mode for discharging to a downstream sound attenuation device and is operable temporarily in a second mode for discharging to atmosphere for boosting operation of the turbine in response to reduced wind forces resulting from a low wind condition.

### BACKGROUND

In the field of generating commercial scale electricity by using wind energy to turn a turbine, most typical installations use large open rotor blade devices elevated high up on towers which by the nature of their design have certain issues that compromise their overall effectiveness. Their open rotor blades, are vulnerable to destructive wind gusts and being elevated on towers makes them difficult to service and repair. They are also noisy, hazardous to birds, they create vibrations harmful to animals, and for many people they are generally regarded as unsightly. In terms of energy production open air rotor blades are largely inefficient in capturing and converting wind energy to electricity and they require high winds in order to function which are then only found in select areas often remote from the power grid. Previous attempts to enclose a turbine in a duct are generally not well suited for capturing enough wind forces for large scale energy production. Furthermore, in the field of generating commercial scale electricity by using wind energy to turn a turbine rotor within a wind turbine assembly, the continued rotation of the turbine at a consistent rate to generate a dependable rate of electricity generation is difficult to achieve in view of the inconsistencies in the available wind.

### SUMMARY OF THE INVENTION

The invention relates to the generation of electricity using wind energy.

The invention uses large scale wind funnels located within structures to increase wind speed and power to efficiently turn a turbine and generator at high speeds to produce electricity for commercial distribution in the range of 20 to 40 megawatts and more for one average sized structure.

The wind funnel structures can be made in a variety of forms and can be situated in many locations. Where the invention is located on land the preferred embodiments will simulate the appearance of a building such as a house, barn, or other building forms. In these ways the preferred embodiments can aesthetically integrate with the local environment and be an acceptable element to people where the invention is located.

The invention in its preferred embodiments is quiet, efficient, serviceable, bird friendly, easily locatable, and can make an agreeable element in the landscape by aesthetically integrating with its surroundings in the form of a house, barn, or other building form.

According to one aspect of the invention there is provided a wind turbine assembly comprising:

a main building structure substantially at ground level comprising a plurality of upright perimeter walls and a roof spanning over the perimeter walls;

at least one wind turbine supported within the building structure which includes a turbine duct communicating from a turbine inlet to a turbine outlet which is exhausted externally of the main building structure, and a turbine rotor which is rotatable within the turbine duct and which is arranged to be driven to rotate responsive to a flow of air through the turbine duct; and

at least one inlet duct supported with the building structure to communicate from an inlet opening in the perimeter walls of the building structure to an outlet in communication with the turbine inlet of said at least one turbine;

said at least one inlet duct tapering in height and width from the inlet opening in the perimeter walls to the turbine inlet of the turbine duct of said at least one turbine;

at least one canyon structure supported externally of the main building structure, said at least one canyon structure comprising upright channel walls extending generally radially from the main building structure near in height to the main building structure and a cover extending between the channel walls along at least a portion of the canyon structure so as to define an air channel between the walls extending generally radially from the main building structure between an open outer end and an inner end in communication with one or more of the inlet openings in the perimeters walls of the building structure.

Preferably said at least one canyon structure comprises a plurality of canyon structures extending in different radial directions from the main building structure.

The assembly may further comprise: (i) a plurality of the inlet ducts in the main building structure, each communicating with respective ones of the canyon structures; and (ii) a plurality of gate members on the main building structure in association with respective inlet ducts of the main building structure, each gate member being operable between an open position allowing communication of the associated inlet duct with the respective canyon structures and a closed position in which the associated inlet duct is closed and prevented from communication with the respective canyon structures.

The plurality of canyon structures are preferably supported about a full circumference of the main building structure.

Each canyon structure preferably spans circumferentially relative to the main building structure between two adjacent ones of the channel walls which are oriented at approximately 30 degrees relative to one another.

Each canyon structure may include an upright baffle wall oriented radially relative to the main building structure and spanning a height of the air channel at an intermediate location between the upright channel walls of the canyon structure so as to extend partway along a length of the canyon structure from the outer end towards the main building structure.

Each canyon structure may further comprise a plurality of flexible members extending under tension between the upright channel walls of the canyon structure.

A top of the air channel between the upright channel walls of said at least one canyon structure is preferably only partially covered by the cover such that a portion of the top of the air channel remains open to accept air flow therethrough into the air channel.

The cover of said at least one canyon structure is typically parallel to ground level.

The cover of said at least one canyon structure may be formed of flexible material spanning under tension between the upright channel walls of said at least one canyon structure.

The cover of said at least one canyon structure preferably includes a plurality of main cover portions lying in a generally common plane and a plurality of inlet cover portions which extend radially inwardly towards the main building structure at a downward slope into the air channel relative to the generally common plane.

The cover may further include a plurality of inlet apertures in the main cover portions, and a plurality of intake members in association with the inlet apertures respectively so as to extend radially outwardly away from the main building structure at an upward slope away from the generally common plane of the air channel.

The assembly may further comprise: (i) a plurality of canyon structures extending in different radial directions from the main building structure; (ii) at least one turbine centrally located in the main building structure; and (iii) a plurality of inlet ducts in the main building structure, each communicating between respective ones of the canyon structures and the centrally located at least one turbine.

The turbine(s) is preferably exhausted upwardly through a common exhaust duct which is exhausted through the roof of the main building structure. The common exhaust duct may be exhausted externally of the building through covered roof vents which are exhausted laterally.

The plurality of turbines may drive rotation of a common drive shaft which turns rotation of an electric generator supported in the main building structure below said at least one turbine. The plurality of turbines are preferably associated with respective ones of the plurality of inlet ducts.

In some embodiments, there may be a single turbine associated with all of the plurality of inlet ducts. In this instance, a movable transition duct portion is preferably associated with each inlet duct which is movable between an active state forming a portion of a transition duct between the respective inlet duct and the turbine inlet of said single turbine while closing communication between other ones of the inlet ducts with the turbine inlet of said single turbine, and an inactive state in which the associated inlet duct is dosed from communicating with turbine inlet of said single turbine by other ones of the transition duct portions.

The wind turbine assembly may further comprise a booster motor operatively connected to the flywheel so as to be arranged to drive rotation of the flywheel supplementary to the wind forces responsive to a low wind condition in which the wind forces are reduced relative to a normal wind condition. The low wind condition may be determined when a measured wind speed of the flow of wind through the turbine duct falls below a prescribed lower limit, or when a measured rotation speed of the flywheel falls below a prescribed lower limit. Preferably a clutch is arranged to operatively disconnect the booster motor from the flywheel during the normal wind condition and operatively connect the booster motor to the flywheel during the low wind condition.

The wind turbine assembly may yet further comprise: (i) a sound attenuating device for receiving a discharge flow of air being exhausted from the main building structure therethrough so as to attenuate sound in the discharge flow; (ii) a primary exhaust duct communicating between the turbine outlet of the turbine duct of said at least one turbine and the sound attenuating device; (iii) a primary door assembly operatively connected to the primary exhaust duct so as to be operable between a closed position preventing communication between the turbine duct of said at least one turbine and the sound attenuating device through the primary exhaust duct, and an open position in which the primary exhaust duct is substantially unobstructed by the primary door assembly; (iv) a secondary exhaust duct communicating from the turbine outlet of the turbine duct of said at least one turbine externally to atmosphere; (v) a secondary door assembly operatively connected to the secondary exhaust duct so as to be operable between a closed position preventing communication between the turbine duct of said at least one turbine to the atmosphere through the secondary exhaust duct, and an open position in which the secondary exhaust duct is substantially unobstructed by the secondary door assembly.

The secondary exhaust duct preferably includes a diverging duct section in which a cross sectional area of the secondary exhaust duct increases in a downstream direction away from the duct outlet of the turbine duct so as to be arranged to boost power generated by the turbine in the second mode of operation relative to the first mode of operation.

Typically, the first mode of operation corresponds to a normal wind condition and the second mode of operation corresponds to a low wind condition in which the low wind condition may be determined either when a measured wind speed of the flow of wind through the turbine duct falls below a prescribed lower limit, or when a measured rotation speed of the turbine falls below a prescribed lower limit.

According to another aspect of the invention there is provided a wind turbine assembly comprising:

a turbine duct arranged to receive a flow of wind therethrough in a longitudinal direction of the duct;

a turbine rotor supported within the turbine duct for rotation about a turbine rotor axis so as to be arranged to be rotated responsive to wind forces from said flow of wind through the turbine duct;

a flywheel operatively connected to the turbine rotor so as to be arranged to rotate together with the rotation of the turbine;

an electric generator operatively connected to the flywheel so as to be arranged to generate electricity responsive to rotation of the flywheel;

a booster motor operatively connected to the flywheel so as to be arranged to drive rotation of the flywheel supplementary to the wind forces responsive to a low wind condition in which the wind forces are reduced relative to a normal wind condition.

The low wind condition may be determined when a measured wind speed of the flow of wind through the turbine duct falls below a prescribed lower limit, or when a measured rotation speed of the flywheel falls below a prescribed lower limit.

The booster motor may be supported within a hub at the turbine rotor axis.

The assembly may further comprise a clutch arranged to operatively disconnect the booster motor from the flywheel during the normal wind condition and operatively connect the booster motor to the flywheel during the low wind condition.

The clutch, which is arranged to operatively disconnect the booster motor from the flywheel during the normal wind condition in a disengaged position and operatively connect the booster motor to the flywheel during the low wind condition in an engaged position, may further comprise a first clutch plate rotatable with the flywheel and a second clutch plate rotatable with an output of the booster motor in which the first and second clutch plates are axially movable relative to one another between the engaged and disengaged positions of the clutch.

The flywheel may be incorporated into the turbine rotor as a unitary member rotatable about the turbine rotor axis such that the turbine rotor effectively is the flywheel.

An auxiliary rotor may be supported within the turbine duct for rotation about the turbine rotor axis so as to be arranged to be rotated responsive to wind forces from said flow of wind through the turbine duct. Similarly, an auxiliary flywheel may be incorporated into the auxiliary rotor as a unitary member rotatable about the turbine rotor axis such that the auxiliary rotor is also effectively a flywheel.

The electric generator may comprise a first generator driven to rotate by the turbine rotor and a second generator driven to rotate by the auxiliary rotor independently of the first generator.

The assembly may further include a booster fan arranged to provide a supplementary flow of air through the turbine duct in response to the low wind condition either in addition to operation of the booster motor, or as an alternative to operation of the booster motor as selected by an operator.

According to a further aspect of the present invention there is provided a wind turbine assembly comprising:

a turbine duct extending in a longitudinal direction from a duct inlet to a duct outlet so as to be arranged to receive a flow of wind through the turbine duct in the longitudinal direction;

a turbine rotor supported within the turbine duct for rotation about a turbine rotor axis so as to be arranged to be rotated responsive to wind forces from said flow of wind through the turbine duct;

an electric generator operatively connected to turbine rotor so as to be arranged to generate electricity responsive to rotation of the rotor;

an auxiliary exhaust assembly for receiving a discharge flow of air therethrough from the duct outlet of the turbine duct;

a primary exhaust duct communicating between the duct outlet of the turbine duct and the auxiliary exhaust assembly;

a secondary exhaust duct communicating from the duct outlet of the turbine duct externally to atmosphere;

at least one door assembly operable in a first mode in which a majority of the discharge flow of air from the duct outlet of the turbine duct is directed through the primary exhaust duct and a second mode in which a majority of the discharge flow of air from the duct outlet of the turbine duct is directed through the secondary exhaust duct.

The secondary exhaust duct may include a diverging duct section in which a cross sectional area of the secondary exhaust duct increases in a downstream direction away from the duct outlet of the turbine duct so as to be arranged to boost power generated by the turbine in the second mode of operation relative to the first mode of operation.

According to another aspect of the invention there is provided a wind turbine assembly comprising:

a turbine duct extending in a longitudinal direction from a duct inlet to a duct outlet so as to be arranged to receive a flow of wind through the turbine duct in the longitudinal direction;

a turbine rotor supported within the turbine duct for rotation about a turbine rotor axis so as to be arranged to be rotated responsive to wind forces from said flow of wind through the turbine duct;

an electric generator operatively connected to turbine rotor so as to be arranged to generate electricity responsive to rotation of the rotor;

a sound attenuating device for receiving a discharge flow of air therethrough so as to attenuate sound in the discharge flow;

a primary exhaust duct communicating between the duct outlet of the turbine duct and the sound attenuating device;

a primary door assembly operatively connected to the primary exhaust duct so as to be operable between a closed position preventing communication between the turbine duct and the sound attenuating device through the primary exhaust duct, and an open position in which the primary exhaust duct is substantially unobstructed by the primary door assembly;

a secondary exhaust duct communicating from the duct outlet of the turbine duct externally to atmosphere;

a secondary door assembly operatively connected to the secondary exhaust duct so as to be operable between a closed position preventing communication between the turbine duct to the atmosphere through the secondary exhaust duct, and an open position in which the secondary exhaust duct is substantially unobstructed by the secondary door assembly.

The arrangement of the primary and secondary exhaust ducts permits operation of the turbine mode under normal wind conditions to direct the discharge flow of air from the turbine to the sound attenuating device. When under low wind conditions however, less sound attenuation is required, and therefore it is more desirable to operate the turbine more efficiently by venting to atmosphere to reduce back pressure on the turbine. The exhaust ducts enable the reconfiguration to direct discharge air flow from the turbine directly to atmosphere rather than through the sound attenuating device.

The turbine may be configured as a flywheel by constructing the turbine blades to be more heavily weighted then is structurally necessary, and by concentrating the extra mass towards the outer periphery of the rotor.

The turbine assembly is preferably operated with a controller adapted to open the primary door assembly and close the secondary door assembly when operating in a normal wind condition, and to close the primary door assembly and open the secondary door assembly when operating in a low wind condition in which wind forces are reduced relative to the normal wind condition.

The low wind condition may be determined when a measured wind speed of the flow of wind through the turbine duct falls below a prescribed lower limit, or when a measured rotation speed of the turbine falls below a prescribed lower limit, or by a combination of various means.

The exhaust ducts may be used in combination with a booster motor operatively connected to the turbine rotor so as to be arranged to drive rotation of the turbine rotor supplementary to the wind forces responsive to the low wind condition.

The exhaust ducts may also be used in combination with a booster fan arranged to provide a flow of air through the turbine duct responsive to the low wind condition, in addition to or instead of the use of the booster motor.

### BRIEF DESCRIPTION OF THE DRAWINGS

Various embodiments of the invention will now be described in conjunction with the accompanying drawings in which:

FIG. 1 is a top plan view of a first embodiment of the wind turbine assembly with the covers of the canyon structures shown removed for illustrative purposes;

FIG. 2 is a top plan view of the wind turbine assembly according to the first embodiment of FIG. 1 in which some of the canyon structures are shown covered;

FIG. 3 is a sectional view of the central main building structure along the line H-H of FIG. 1;

FIG. 4 is a sectional view of one of the canyon structures along the line H-H of FIG. 1;

FIG. 5A is a partly sectional end view of one of the channel walls according to the first embodiment of FIG. 1;

FIG. 5B is an elevational view of the outer end of one of the channels according to the first embodiment of FIG. 1;

FIG. 6 is an enlarged portion of the sectional view according to FIG. 4 illustrating some of the cover portions;

FIG. 7 is a sectional view of the main building structure along a horizontal plane is viewed from above according to the first embodiment of FIG. 1;

FIG. 8 is an enlarged portion of the sectional view according to FIG. 7;

FIG. 9 is an enlarged portion of the sectional view according to FIG. 3;

FIG. 10 is a sectional view of the central main building structure along the line H-H in FIG. 1 according to a second embodiment of the wind turbine assembly;

FIG. 11 an enlarged portion of the sectional view according to FIG. 10 relating to the second embodiment of the wind turbine assembly;

FIG. 12A is a first variant of the front elevational view of the main building structure according to either one of the first or second embodiments of FIG. 3 or 10 respectively, in which the channel walls are transparent for illustrative purposes;

FIG. 12B is a second variant of the front elevational view of the main building structure according to either one of the first or second embodiments of FIG. 3 or 10 respectively;

FIG. 13 is a sectional view of the central main building structure along the line H-H in FIG. 1 according to a third embodiment of the wind turbine assembly;

FIG. 14 is a sectional view of the exhaust ducting along a horizontal plane according to the third embodiment of the wind turbine assembly as shown in FIG. 13;

FIG. 15 is a partly sectional top plan view of a fourth embodiment of the wind turbine assembly;

FIG. 16 is a sectional view along a vertical plane oriented in the longitudinal direction of the turbine duct according to the fourth embodiment of the wind turbine assembly as shown in FIG. 15;

FIG. 17 is a partly sectional elevational view of a fifth embodiment of the wind turbine assembly; and

FIG. 18 is a sectional view along the line A-A FIG. 17 according to the fifth embodiment of the wind turbine assembly as shown in FIG. 17.

In the drawings like characters of reference indicate corresponding parts in the different figures.

### DETAILED DESCRIPTION

The present invention can be used in conjunction with the wind energy system described in International Patent Application No. PCT/CA2015/050904, filed Sep. 16, 2015, U.S. provisional application No. 62/269,634, filed Dec. 18, 2015, U.S. provisional application No. 62/296,309, filed Feb. 17, 2016, and U.S. provisional application No. 62/427,433, filed Nov. 29, 2016, the contents of which are hereby incorporated by reference.

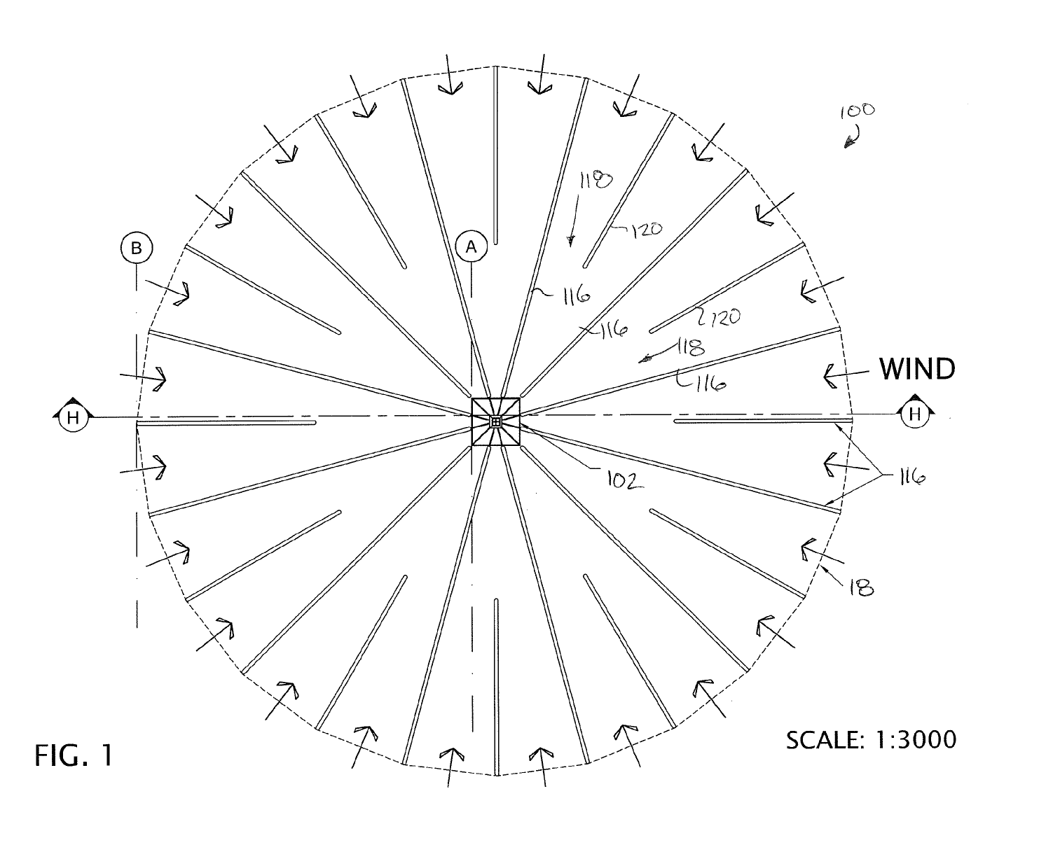

Referring to the accompanying figures, there is illustrated several embodiments of a wind turbine assembly. Although several embodiments are shown in the accompanying figures, the common features of FIGS. 1 through 14 will first be described.

According to FIGS. 1 to 14, the wind turbine assembly 100 generally includes a main building structure 102 located substantially at ground level. The main building structure comprises a plurality of upright perimeter walls 101 and a roof 103 spanning over the perimeter walls to enclose the top side of the building structure. The building structure may take the form of the wind turbine assembly described in the applicant's co-pending patent applications which are appended herein.

The main building structure 102 locates one or more turbines 104 therein. Each turbine generally includes a rotor 106 rotating within a corresponding turbine duct portion 108. The rotor is rotatable within the corresponding turbine duct to be driven to rotate responsive to a flow of air through the turbine duct from channeled wind flows.

A plurality of inlet ducts 110 are supported within the building structure to taper inwardly from respective inlet openings 112 located at the perimeter of the building structure, towards the centrally located one or more turbines 104. In the illustrated embodiment, the main building structure is rectangular in shape such that there are inlet openings 12 in all four sides of the perimeter walls of the building structure. Each inlet duct thus communicates generally radially inwardly from a respective one of the walls of the building structure to the centrally located one or more turbines.

The overall building structure is typically constructed to generally resemble a residential building. For example, the building structure may be constructed at ground level to be approximately 20 to 50 feet, or more, in height corresponding to being between two and four building stories in height. The width and length may be in the order of 50 to 1000 feet each, or more.

The wind turbine assembly described herein is most distinguished by the use of a plurality of canyon structures which surrounds the main building structure 102 for gathering wind towards the respective inlet openings at the perimeter of the building structure. The canyon structures are also constructed substantially at ground level but are located externally of the walls of the main building structure.

Each canyon structure is defined by a respective adjacent pair of channel walls extending radially outward from the building from an inner and to an outer end of the corresponding channel formed by the canyon structure. The channel walls extended generally vertically upward from the ground level of the main building structure to a height which is near a height of the main building structure. The channel walls 116 are evenly spaced apart from one another in the circumferential direction about the full circumference of the main building structure. The corresponding air channel 118 defined between each adjacent pair of channel walls 116 is substantially constant in height between the channel walls but is tapered to be reduced in width in the circumferential direction relative to the main building along the length of the air channel in the radial direction from the outer end of the channel which remains open to the inner and which is in communication with a respective inlet opening 112 of the main building structure.

Each air channel 118 also includes a baffle wall 120 supported therein which also extends vertically upwardly from the ground substantially the full height of the air channel at a location which is laterally centred between the respective adjacent pair of channel walls 116. The baffle wall extends only part of the radial length of the respective air channel within which it is received so as to extend from the other end of the air channel only part way towards the building.

In the illustrated embodiment, 12 channel walls 116 are provided such that the channel walls are each oriented that a slope of 30° to the adjacent walls. Furthermore, the open end of each air channel defined between each pair of channel walls spends an arc of approximately 30° about the circumference of the main building structure. The opening to find between each baffle wall 120 and each of the adjacent channel walls this corresponds approximately to an arc of 15° with the baffle wall 120 being oriented at a slope of 15° to each of the adjacent channel walls between which it is centred in the circumferential direction. In view of the rectangular shape of the main building structure having four sides, the canyon structures are arranged such that three air channels 118 are supported in communication with the inlet openings of each of the four sides of the main building structure.

The channel walls and the baffle walls are supported at their bottom ends in the ground by forming a trench receiving a concrete foundation therein which anchors the bottom end of the wall. Flexible cables spent under tension in the circumferential direction between the adjacent channel walls and between the baffle walls and the adjacent channel walls at the top end and optionally various intermediate levels to provide additional structural support to the walls of the canyon structures.

Each canyon or canyon structure is at least partially enclosed at the top side thereof by a suitable cover 122 spanning generally horizontally between the tops of the channel walls 116. The cover 122 is formed of flexible materials including flexible sheeting such as tarps and the like supported by cables under tension which are mounted to spend generally circumferentially between adjacent ones of the walls forming the canyon structures. Typically, gaps are provided between adjacent sections of the cover material to allow air to be introduced into the air channels 118.

More particularly, the cover 122 is formed of a plurality of main cover portions 124 comprising respective panels of cover material which span the full width between adjacent walls of the canyon structures while lying in a generally common horizontal plane with the other cover portions. Some or all of the cover portions are angularly adjustable to function as louvers which can be opened and closed to control the amount of air permitted to enter into the air channels through the top side thereof. Any adjustable main cover portions can be positioned to define a respective inlet cover portion 126 which is supported to extend radially inwardly towards the main building structure at a downward slope extending into the air channel 118 relative to the common plane of the main cover portions 124. More particularly the inlet cover portion 126 comprises a panel having its outermost edge in a substantially common plane with the main cover portions while the inner edge is located downwardly and radially inwardly relative to the outer edge to define an opening immediately above the inner edge allowing air to enter into the air channel.

Some of the main cover portions 124 may be further provided with inlet apertures 128 also allowing air to enter through the top side of the air channel. Each inlet aperture 128 is typically provided with an intake member 130 in the form of a scoop which extends upwardly from an innermost edge of the aperture at a radially outward slope so as to protrude above the common plane of the main cover portions 124 with an intake opening oriented to face radially outwardly away from the main building structure. The intake members this range to scoop air passing over the cover 122 to be redirected inwardly into the air channel to join the flow of air within active canyon structures flowing inwardly towards the main building structure.

Each resulting canyon structure is substantially constant in height along the length thereof in the radial direction while being tapered horizontally to be reduced in width from the other end to the inner end. Each channel structure is a large-scale structure such that each canyon structure may spend radially outwardly from the main building structure in the range of 50 m to 500 m or more for example.

Turning no more particularly to the main building structure 100, the main building structure includes a central exhaust duct 132 located centrally between the perimeter walls so as to extend generally vertically upward from the one or more turbines to exhaust the turbines through the roof of the building structure. A plurality of roof vents 134 are provided in the roof to form respective exhaust openings which are directed laterally outwardly so as to be covered from above for preventing the entry of rain and the like.

The one or more turbines are connected by a suitable drive assembly to a common drive shaft 136 which is driven to rotate by the one or more turbines collectively. The driveshaft 136 communicates through boundary walls of the ducts using suitable bearings able to maintain air pressure differential. The driveshaft 136 extends vertically downward for driving the rotation of one or more electric generators supported within the Main building structure below the one or more turbines. The driveshaft drives a flywheel 138 connected in series with the one or more generators 137.

A booster motor 140 is selectively coupled to the driveline to boost the wind power normally driving the flywheels 138 and generators 137 in the event of a low wind condition. The booster motor 140 includes a clutch incorporated between the booster motor and the respective flywheel 138 which is operable between an engaged position in which the booster motor engages with the flywheel to drive rotation of the flywheel supplementary to the wind forces driving rotation thereof, and a disengaged position in which the booster motor is disengaged from the driveline between the gearbox at the bottom of the common shaft 136 and the flywheel. In the disengaged position, the flywheel is thus driven to rotate solely under force of the wind driving the one or more turbines.

Under normal operating conditions, with sufficient wind forces, the booster motors remain inactive and inoperative. The wind turbine assembly is arranged to determine a low wind condition when i) the measured wind speed in the turbine duct upstream from the turbine rotors falls below a prescribed lower limit, or ii) the measured speed of rotation of one or both turbine rotors and incorporated flywheels falls below a prescribed lower limit, or iii) any other suitable sensing means indicative of low wind, or iv) any combination of the above.

In response to the determination of a low wind condition, a controller of the wind turbine assembly is arranged to automatically actuate either one or all of the booster motors. In the event of the booster motor being actuated, the booster motor serves to maintain the speed of rotation of the associated flywheel above a prescribed minimum rotation speed to ensure a minimum power generating capacity of the electric generator is met. Typically, one or all of the booster motors are operated intermittently in small bursts to maintain flywheel rotation speed.

Each of the inlet ducts is tapered in both width and height from the respective inlet opening in one of the perimeter walls of the main building structure to centrally located transition ducting communicating the inlet duct with the one or more turbines.

Turning now more particularly to the embodiment of figure is 1 through 9, in this instance four turbines are provided such that one turbine is associated with each one of the inlet ducts respectively. In this instance, each turbine communicates with a respective transition duct 142 which transitions from the square shape of the inlet duct to the round shape of the corresponding turbine duct. The outlet of the turbine duct communicates with a common central space 144 surrounded by a suitable transition casing 146. The transition casing is open at the top side thereof while including inlets on four sides communicating with the four turbine ducts respectively. The casing is exhausted upwardly into the exhaust duct there above.

Outer gate members 148 are provided at each inlet opening in the perimeter walls of the main building structure for selectively closing any inlet openings which are not actively being used to drive a respective turbine for generating electricity. Specifically, under little wind speed conditions or wind speeds which are below a minimum criteria, the outer gate members of the relevant channel structures having low wind speed are closed.

Typically, only one turbine is active when incoming wind is perpendicular to one of the sides of the housing, or two adjacent turbines are active when wind is directed towards the main building structure at a slope to two adjacent sides of the rectangular building structure.

An inner gates member 150 is typically provided in association with each inlet duct in close proximity to the respective turbine to close communication of the central casing 146 to any inlet ducts associated with inactive turbines to prevent an active turbine from exhausting through the corresponding duct of an inactive turbine.

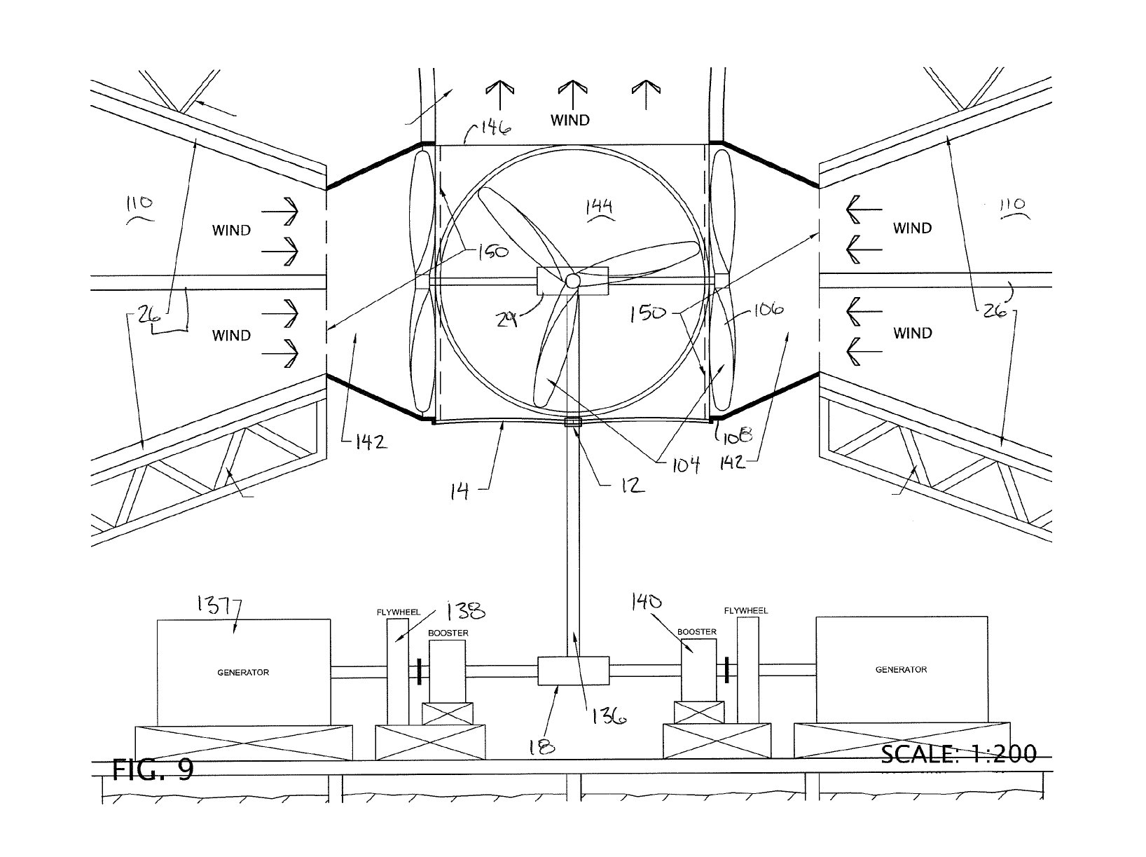

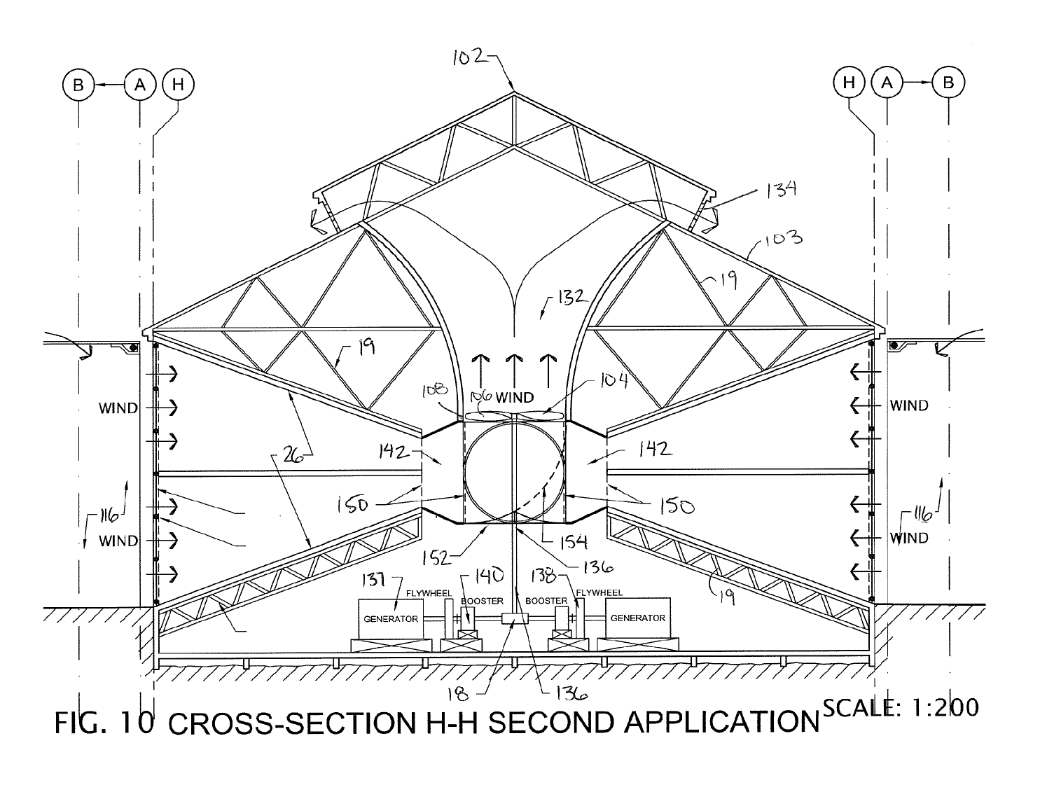

Turning now to the embodiment of FIG. 10, in this instance the one or more turbines comprises a single turbine located within a respective turbine duct which is vertically oriented so as to be coaxial with the exhaust duct there above. The inlet of the turbine duct in this instance communicates with a common central transition casing 152. The central transition casing 152 has inlets at four sides about the perimeter thereof for receiving airflow from the square to round transition ducts 142 of the four inlet ducts 110 respectively. The central transition casing 152 includes a plurality of movable transition duct portions comprising flexible boundaries which can be extended, retracted or varied in shape to change which inlet ducts communicate with the inlet of the single turbine.

A respective movable transition duct portion 154 is associated with each inlet duct so as to be operable between active and inactive states relative to the respective inlet duct. In an active state, the transition duct portion 154 forms a gradually curved boundary functioning is a 90° elbow transition from the respective inlet duct 110 to the inlet of the turbine there above. While serving to redirect flow from the respective inlet duct with which it is associated, the flexible boundary of the transition duct portion also serves to close off communication of other inlet ducts which are not in use due to low wind speed. In the inactive state, the flexible boundary of the transition duct portion 154 is retracted or stored such that the respective inlet duct with which it is associated is closed off from communicating with the turbine by the movable boundaries of transition duct portions associated with other inlet ducts.

In operation, low-speed wind approaching the main building structure from any direction is accumulated within the corresponding canyon structures having open ends facing into the wind. The gradually reducing cross-sectional area of the air channel within each active canyon structure serves to accelerate the airflow through the air channel. The accelerated airflow can be accelerated with additional incoming air entering through gaps in the cover over the active canyon structures. The accumulated airflow then enters the main building structure through inlet openings associated with the active canyon structures for funneling the airflow to the one or more centrally located turbines within the main building structure.

Various additional features of the wind turbine assembly according to FIGS. 1 through 14 will now be described in the following.

FIG. 1 shows the canyon walls 116 which are high walls converging to one point as a funnel. The main building structure 112 is a wind house at the central convergence of the channel walls 116 to activate four turbines or single turbine system in the main building structure. Grid line ‘A’ to grid line ‘B’ indicates the two ends of one of the canyon walls 116. This drawing shows the formation of high walls to create the urban canyon but rather than have very high walls the effect of the high walls is mitigated by the funnel shape.

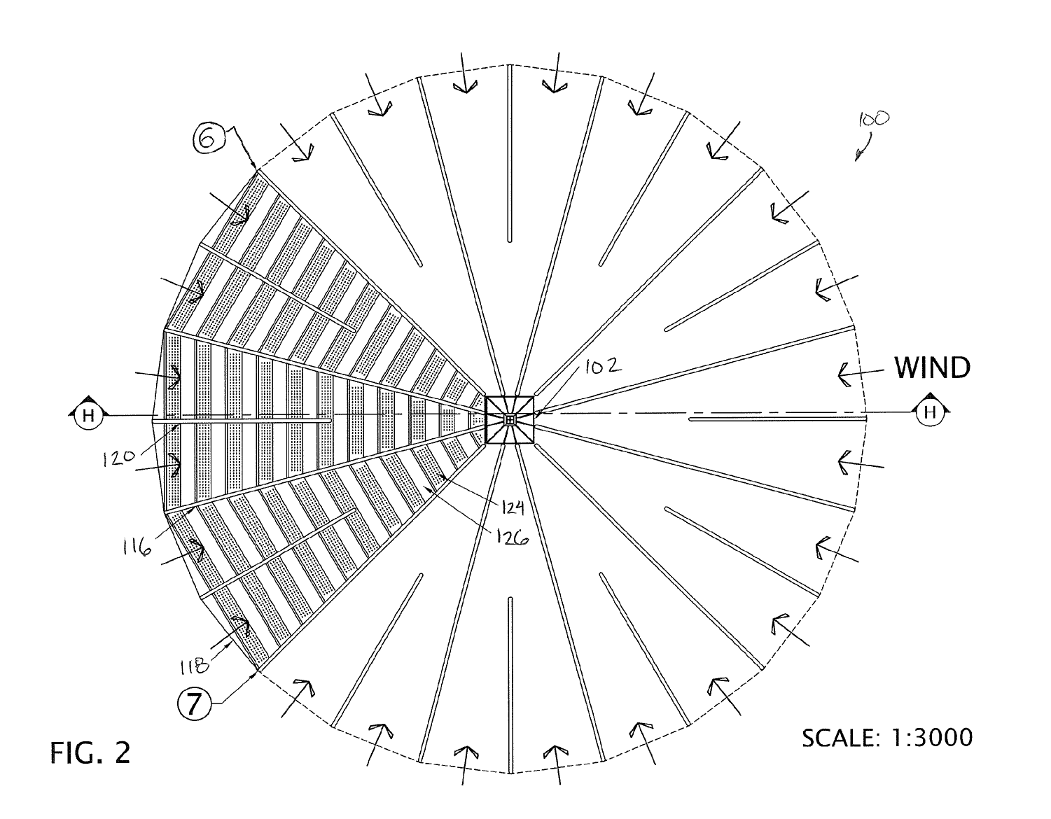

FIG. 2 shows a section between reference lines 6 and 7 that a segment of walls partly covered by metal or fireproof tarp the walls can be made from any fireproof materials. The tarp forming the cover 122 is a flat tarp with louvers 130 that bring slow moving air outside to the main stream wind to allow the fast moving wind to drag fresh air molecules. The main building structure includes multiple funnels 110 in alignment with the channels through inlet openings 112 on all sides of the main building structure. Section ‘H-H’ indicates a cross-section showing the interaction of the walls 116 and the wind house 102. The tarps 122 include a sloping tarp which has also a rough surface to make the lower layers of the wind curved its slope allows the tarp to bring fresh additional fresh air in contact with the main steam wind so that fresh air molecules will be brought in to enhance the main stream wind energy. The tarps of the cover 122 will at times cover only a proportion of the area so that large gaps do not have any cover over. The tarp will be secured to the wall 116 by perimeter cables and diagonal cables at the center of the tarp.

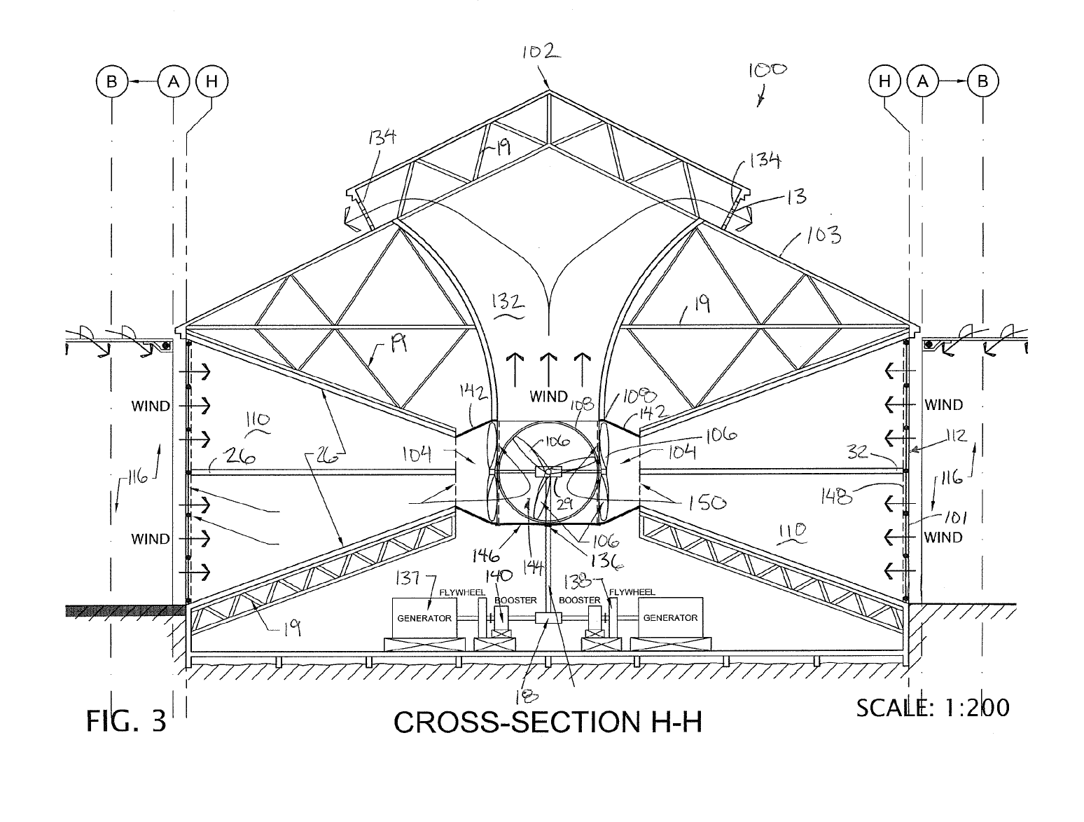

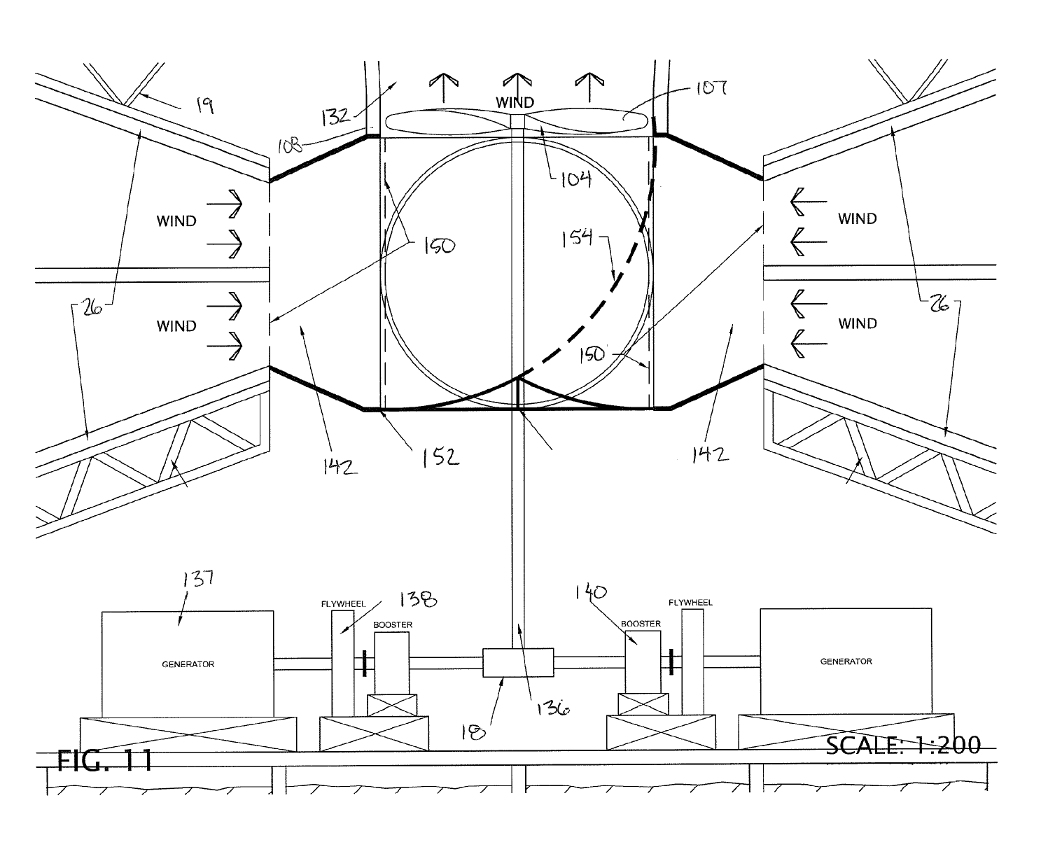

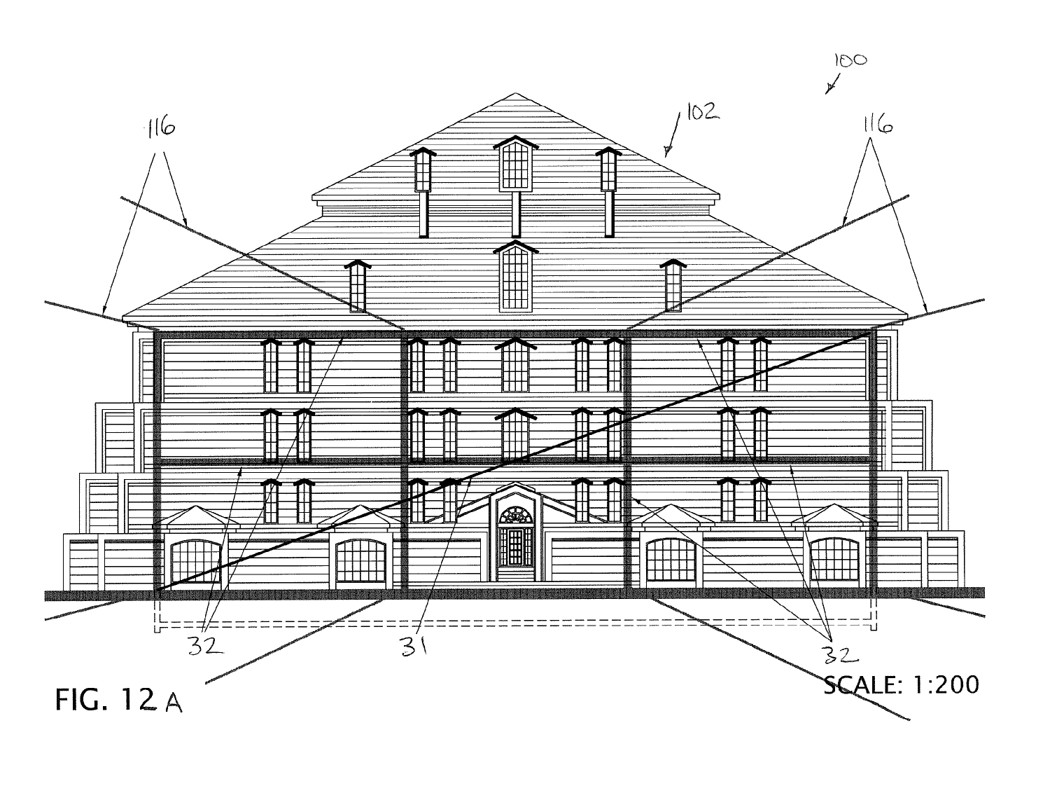

FIG. 3 demonstrates the relationship between the walls 116 and the wind house 102. The wind enters through the inlet openings in the main building through a decorative screen as shown in FIGS. 12A and 12B. A further retractable screen spans over each opening to selectively close the inlet openings which are not actively in use for generating electricity from wind. Wind goes through the funnel walls of the inlet ducts 110 which are made from non-combustible material. The wind reaches the inner gate members 150 which is a retractable screen to stop the wind then the wind goes through the transition duct 142 made from non-combustible material. The metal cone that forms the transition ducts 142 converts the rectangular openings of the walls of the inlet ducts 110 into a circular form to set the turbine. Once the turbine turns it activates rotation of common shaft 136 to drive a central gearbox 18, which rotates a plurality of circumferentially spaced apart flywheels coupled to rotate respective generators 137. The common shaft 136 goes through a diaphragm forming the bottom side of the common central space 144. A suitable seal surrounds the shaft 136 at is passes through the diaphragm to maintain an air tight seal and direction all turbine exhaust upwardly through the central exhaust duct 132. The central exhaust duct is a shroud, or diverging cone that reduces backpressure and exhaust out the roof through the louvers in the roof vents 134 which stop precipitation and back-flow wind from entering into the main building structure therethrough.

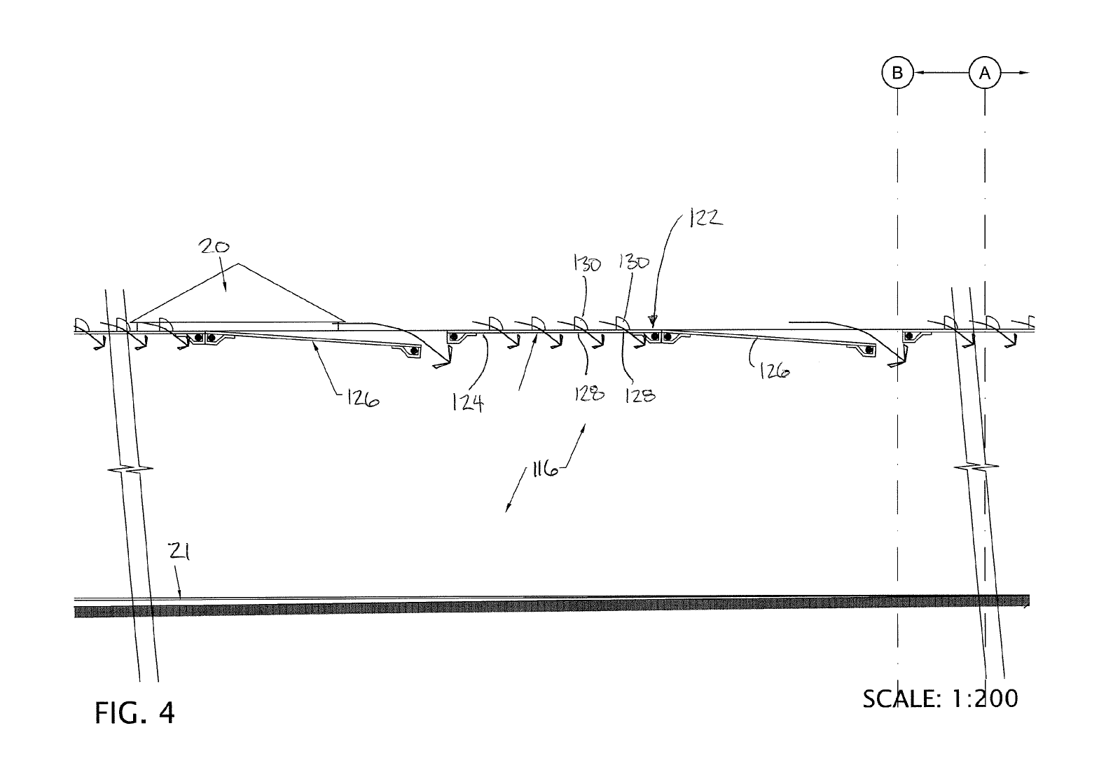

FIG. 4 demonstrates the extent of the walls 116 between grid line ‘A’ and grid line ‘B’. A roof element 20 is provided above the walls 116 to enhance the character of the walls. The top of the foundation 21 is level, however the floor of each channel is sloped slightly downward as it extends radially outwardly from the building structure for drainage.

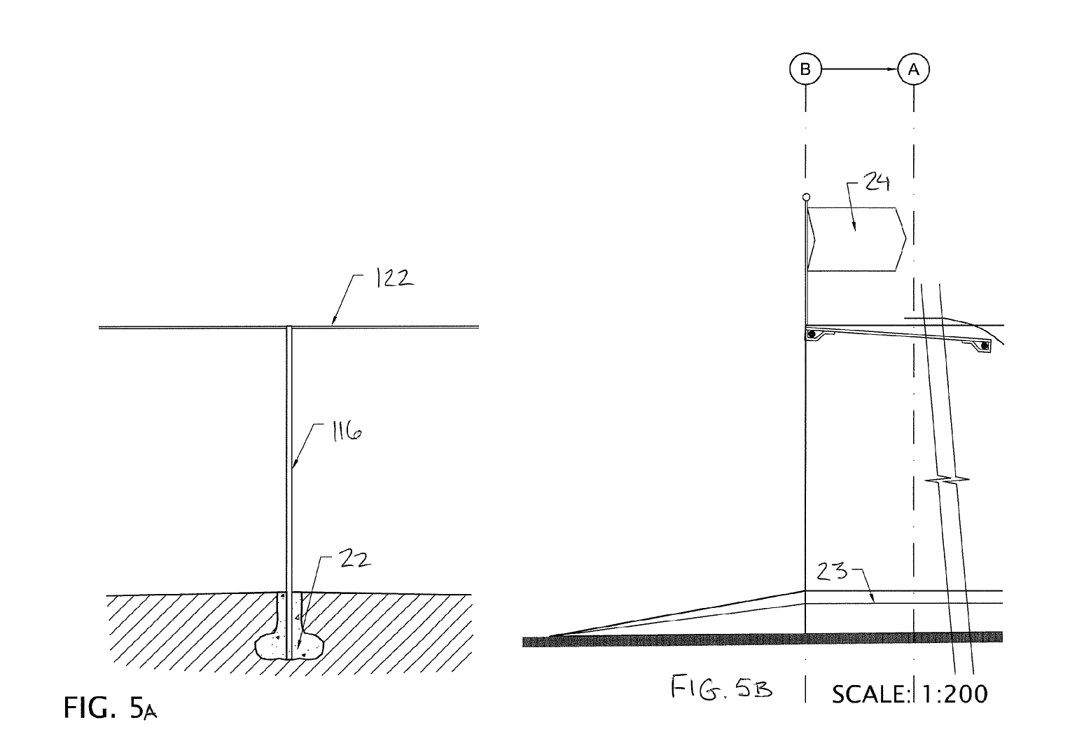

FIGS. 5A and 5B shows the end of the wall at grid line ‘B’ line in which the top of the drainage trench 23 is shown spaced above a solid grey line representing the bottom of the drainage trench. A wind directional flag 24 shows the direction of the wind. The profile of each concrete foundation 22 is constructed as follows. First the trench is dug in the ground and a router opens the bottom bell, then the walls 116 are poured on the ground as slab on grade. When set up, they are lifted and secured in the empty trench, and then concrete fills the cavity of the foundation about the bottom end of the wall 116. The tarps forming the cover 122 are shown as they abut the wall and they are secured by post tension cables.

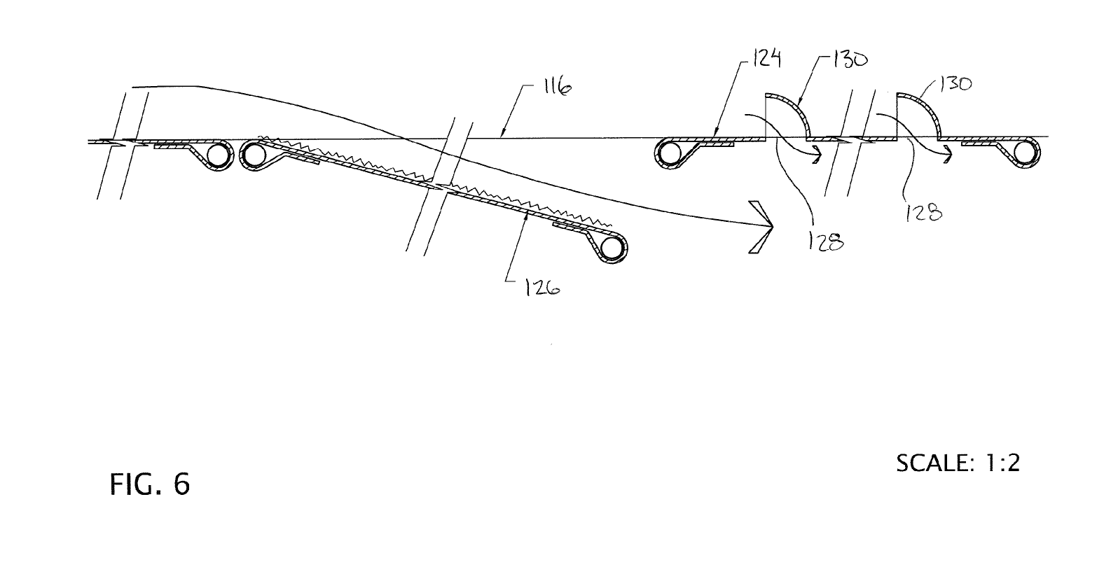

FIG. 6 shows the sloping tarp of the cover 122 which is supported by post-tensioned cables. The upper surface of the tarp is very rough as this allows the wind lower layers to curve in addition to the slope created by the tarp to bring in contact the low speed wind with the high speed wind created between the walls so as to drag fresh air molecules to enhance the energy of the wind going to wind house 102. Other tarps of the cover 122 show louvers 130 to bring fresh low speed wind in contact with high speed wind.

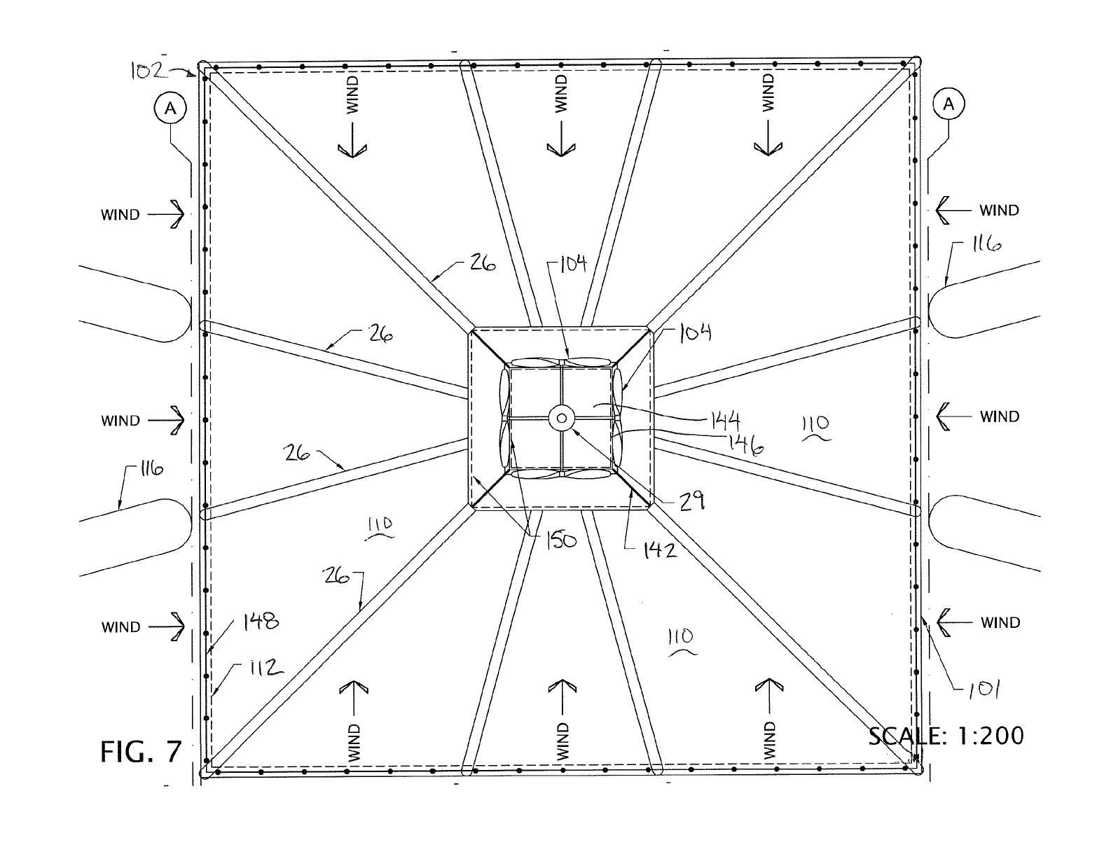

FIG. 7 shows in large detail the relationship between the urban canyon/funnel 118 with the walls of the main building structure 102. The walls of the main building structure are to be made from non-combustible materials. The transition duct 142 is a cone made of non-combustible material that converts the wall opening 112 from rectangular to accept a circular turbine duct.

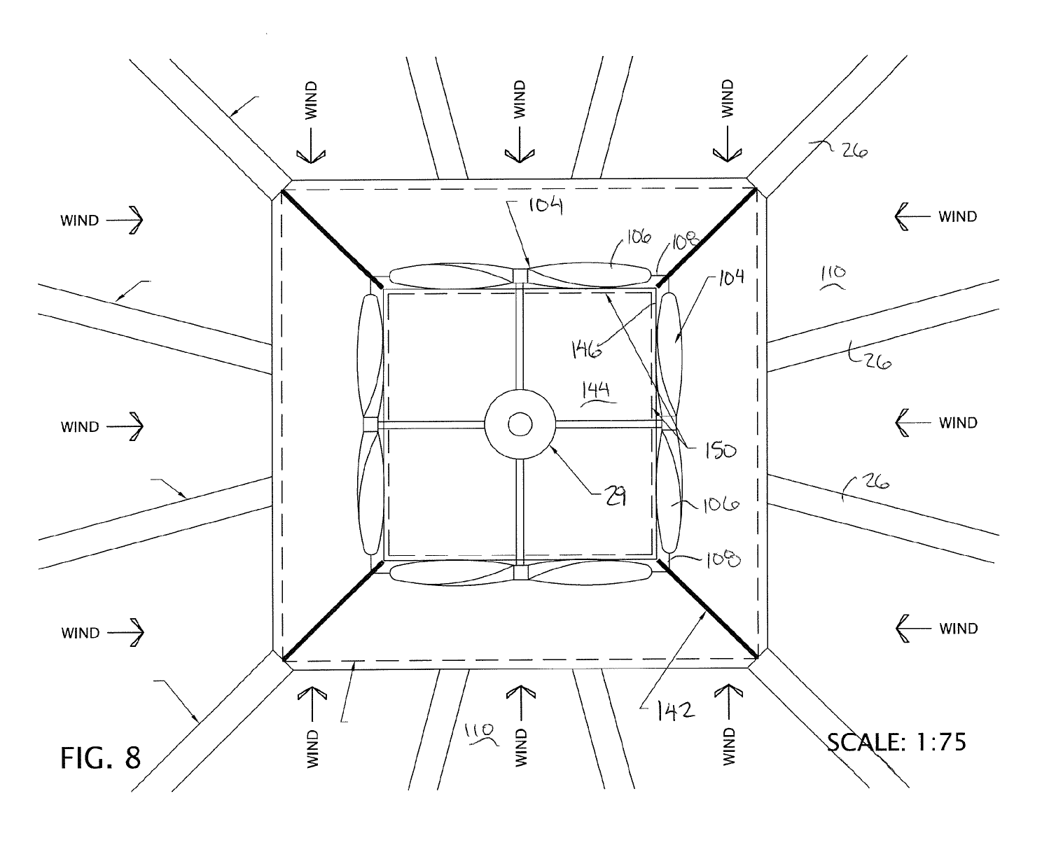

FIG. 8 is a further plan showing the retractable screen 150 associated with each of the four turbines which are designed and located so there will be no loss of energy pressure from the incoming wind. When one turbine turns it activates a respective drive shaft coupled to the other drive shafts and the common central shaft 136 through a gearbox 29 centrally located in the common central space 144. Structural supports 19 are provided within the internal structure of the main building to act as trusses which support the roof and the inlet ducts relative to the perimeter walls and the foundation of the main building structure.

FIG. 9 is an enlarged detailed view of the diaphragm forming the bottom side of the common central space 144 including an air proof seal therein to receive the common central drive shaft 136 extending therethrough from the gearbox 29 above to the gearbox 18 below.

FIG. 10 is a cross sectional view similar to FIG. 3 but for a second embodiment in which the main building structure uses only one turbine installed centrally relative to a main central exhaust duct 132. To minimize any loss of pressure a curved retractable screen 154 is provided which will send the wind upwards into the exhaust shroud 132. In this instance there is only one gearbox 18 required. The bottom side of the central space 144 is provided with a shaped panel curving upwardly and inwardly from all four surrounding transition ducts 142 to a central apex locating the air proof seal therein through which the drive shaft 136 passes. The curved movable boundaries 154 each extend between the central apex and the top end of transition casing 152 at a location diametrically opposed from the inlet duct which is actively being used to funnel wind into the turbine duct to drive the turbine rotation.

FIG. 11 is a large detail schematic showing the adaptation of the curved screen to the ground which is raised appropriately to form a smooth circle.

FIG. 12A is a typical elevation of the four segments of the wind house in which the channel walls 116 are shown as transparent to better illustrate their relationship to the main building structure 102. The grey boundary lines 32 show the perimeter edges of numerous inlet ducts communicating from respective rectangular inlet openings in the perimeter walls of the main building structure. As illustrated, baffles within each main inlet duct separate the inlet duct into six partitioned funnels, arranged in two vertically stacked rows of three funnels laterally across within each row. The partitioned funnels within each inlet duct commonly communicate with a common transition duct 142 associated with that side of the main building structure for subsequently directing air into the transition casing 152 locating the one or more turbines therein. A diagonal line 31 shows the extent of the air intake of the six (6) funnels which is typically located similarly on all four (4) elevations of the main building structure.

FIG. 12B is similar to FIG. 12A but shows in the back elevation a ramp extending below grade to located a man door and a garage door for access to the inside of the main building structure 102 for maintenance and the like.

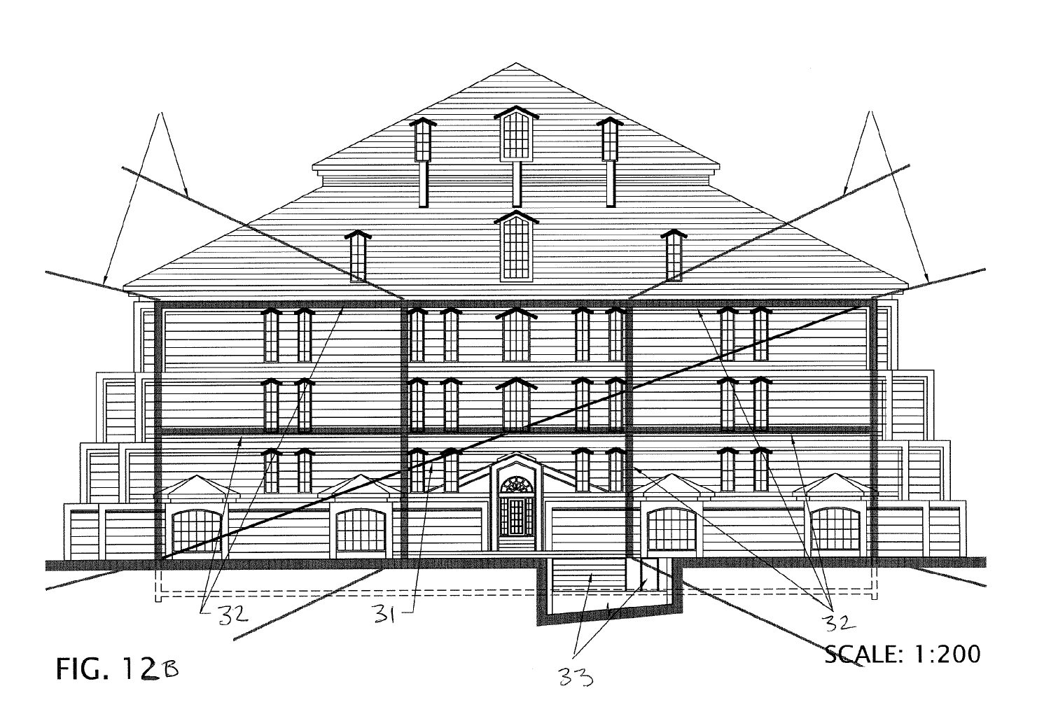

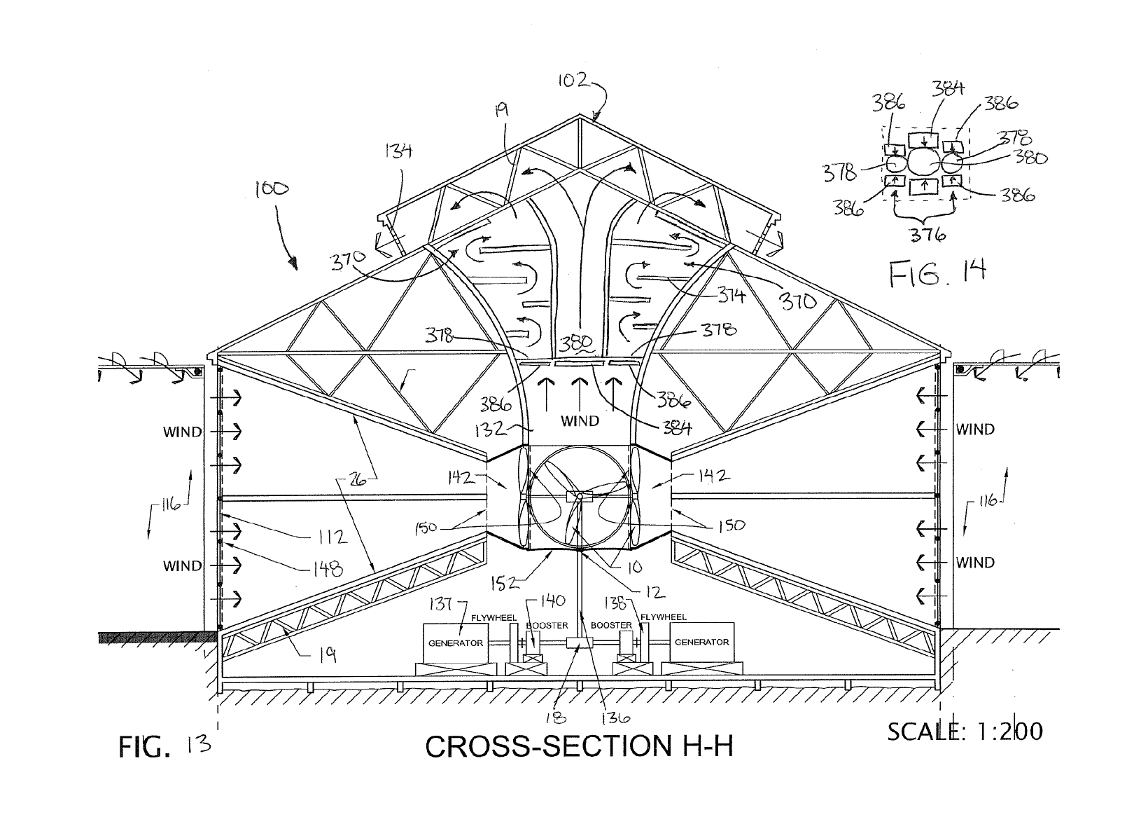

Turning now to the embodiment of FIGS. 13 and 14, the general structure of the wind turbine assembly 100 in this instance is identical to the first embodiment of FIGS. 1 through 9, with the exception of the configuration of the central exhaust duct 132. As shown in FIGS. 13 and 14, the wind turbine assembly is arranged to distinguish between a normal operating condition, with sufficient wind forces, and a low wind condition. The wind turbine assembly is arranged to determine a low wind condition when i) the measured wind speed in one or more of the turbine ducts upstream from any active turbine rotors falls below a prescribed lower limit, or, ii) the measured speed of rotation of one or more turbine rotors and/or one of more of the associated flywheels 138 falls below a prescribed lower limit, or iii) any other suitable sensing means indicative of low wind, or iv) any combination of the above.

In response to a determination available wind condition, a controller of the wind turbine assembly may also reconfigure the exhaust from the outlet of the central exhaust duct 132, to boost turbine efficiency by reducing outlet back pressure under low wind conditions.

Under normal operation, the discharge flow of air exhausted from the outlet of the central exhaust duct 132 is directed to a sound attenuation device 370. The sound attenuation device comprises a plurality of baffles 374 supported within respective exhaust ducts which define a sinuous flow path for receiving the discharge flow of air from the turbine outlet therethrough in a manner which attenuates sound in the discharge flow.

A primary exhaust duct 376 is provided in the form of a plurality of primary passages 78 which collectively define the primary exhaust duct 376 for communicating from the outlet of the central exhaust duct 132 to the inlet of the sound attenuating device.

A secondary exhaust duct 380 is aligned concentrically with the outlet of the central exhaust duct 132 at an inlet end for communication from the outlet of the central exhaust duct 132 to the surrounding atmosphere. The outlet end of the secondary exhaust duct includes a plurality of laterally oriented outlet passages which are vented externally to the atmosphere towards laterally opposing sides of the secondary exhaust duct.

The secondary exhaust duct 380 includes a diverging duct section in which a cross sectional area of the secondary exhaust duct increases in a downstream direction away from the duct outlet of the central exhaust duct 132 so as to be arranged to boost power generated by the turbine when the discharge flow of air from the outlet of the central exhaust duct 132 is directed through the diverging duct section.

The primary exhaust duct 376 specifically includes two primary passages is 378 located at diametrically opposed sides of the secondary exhaust duct 380. A manifold section 382 collectively communicates from the outlet of the turbine duct 312 to the inlet of the secondary passages 378 of the primary duct and the singular passage of the secondary duct 380 therebetween. Alternately, the primary exhaust duct may be an annular duct surrounding the centrally located secondary duct 380.

A secondary door assembly comprised of two secondary doors 384 is mounted at the communication between the manifold section 382 and the inlet of the secondary exhaust duct 380. The two doors 384 are mounted in a common plane oriented perpendicularly to the longitudinal flow direction through the secondary duct. The two doors are slidable within a respective plane of the doors from diametrically opposed sides of the secondary duct to be movable in a lateral direction between an open position in which the doors are spaced apart and the secondary duct is unobstructed by the doors 384 for directing the discharge flow of air to atmosphere, and a closed position in which the two secondary doors 384 abut one another to fully close the secondary exhaust duct and prevent flow of discharge air therethrough.

Similarly, each primary passage 378 of the primary duct 376 is provided with a pair of primary doors 386 at the communication between the manifold section 382 and the inlet of the primary passages. The two primary doors 386 of each primary passage are mounted in a common plane oriented perpendicularly to the longitudinal flow direction through the primary passages. The two doors 386 are slidable within a respective plane of the doors from diametrically opposed sides of the primary passage to be movable in a lateral direction between an open position in which the doors are spaced apart and the primary passage is unobstructed by the doors for directing the discharge flow of air therethrough to the sound attenuation device, and a closed position in which the primary doors abut one another to fully close the primary passages and prevent flow of discharge air therethrough.

Under normal operating conditions, the secondary doors 384 are closed and the primary doors 386 are opened to direct all discharge flow from the outlet of the turbine to the sound attenuating device. The controller is coupled to suitable actuators which operate the doors between the open and closed positions thereof. Accordingly, upon determination of a first low wind condition, the controller can open the secondary doors and close the primary doors so that discharge air is vented directly to atmosphere through the diverging duct section 380 instead of through the sound attenuating device. This has the effect of reducing back pressure on the turbine to increase the operating efficiency of the turbine temporarily until a normal wind condition resumes.

Operation of the door assemblies from the normal operating mode to a low condition mode can be performed as a first response to a low wind condition before operation of the booster motors 140. Alternatively, the door assemblies may be automatically switched to the low wind condition mode together with operation of any one or more of the booster motors 140.

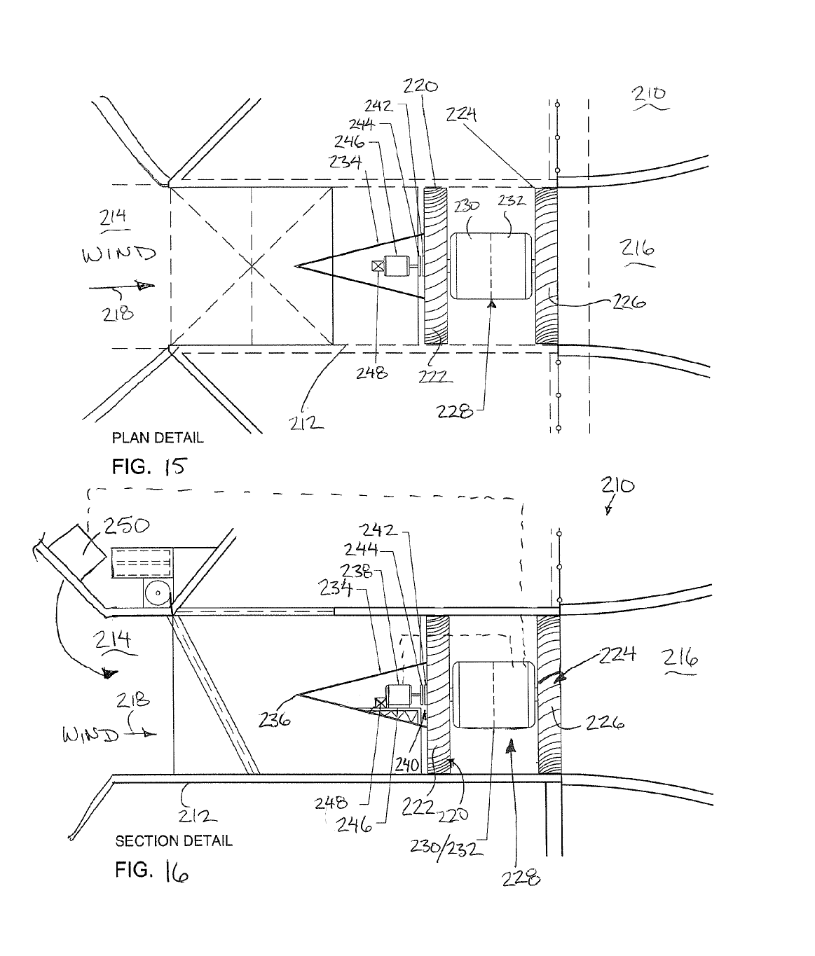

Turning now to FIGS. 15 and 16, there is illustrated a further embodiment of the wind turbine assembly generally indicated by reference numeral 210. The assembly 210 generally includes a turbine duct 212 which extends in a longitudinal direction between an inlet end 214 and an outlet end 216 for receiving a flow of wind therethrough generally in a wind direction 218.

A first turbine rotor 220 is rotatably supported within the turbine duct for rotation about a turbine rotor axis oriented in the longitudinal direction of the duct. The rotor 220 fully spans the cross-sectional area of the turbine duct and includes a plurality of blades 222 arranged to drive rotation of the turbine rotor responsive to wind forces from the flow of wind through the turbine duct in the wind direction. In addition to the blades 222, the first turbine rotor 220 also incorporates a flywheel, for example in the form of a peripheral mass which extends circumferentially about the perimeter of the blades 222 for rotation together with the rotor relative to the duct.

A second turbine rotor 224 is also rotatably supported within the turbine duct downstream from the first turbine rotor for rotation about the same turbine rotor axis. The second turbine rotor 224 similarly fully spans the cross-sectional area of the turbine duct and includes a plurality of blades 226 also arranged to drive rotation of the respective turbine rotor responsive to wind forces from the flow of wind through the turbine duct in the wind direction. The second turbine rotor also incorporates a flywheel, which may also be in the form of a peripheral mass extending circumferentially about the perimeter of the blades for rotation together with the rotor relative to the duct.

Typically, each turbine rotor is constructed such that the blades are lighter towards a center of the turbine and most of the mass of the turbine is located at the periphery by additional weighted flywheel masses or by arranging the blades to have a greater mass towards the outer periphery of the rotor.

An electric generator 228 is mounted within the turbine duct between the first and second turbine rotors at a central location in line with respective central hubs of the two rotors. Location of the generator between the rotors results in the first turbine rotor 220 being located upstream from the generator and the second turbine rotor 224 being located downstream from the generator. The generator includes a first portion 230 which is driven to rotate by a shaft connection to the first turbine rotor 220 and a second portion 232 which is driven to rotate by a shaft connection to the downstream second turbine rotor 224. In one instance, the first and second portions of the generator drive a common generator unit by linking the respective shafts to rotate together such that the turbine rotors in turn are rotated together. Alternatively, the first and second portions may comprise independent generator units, each driven to rotate by the respective turbine rotor such that the turbine rotors are rotated independently of one another.

A conical housing 234 is mounted upstream of the first turbine rotor directly adjacent the hub of the turbine rotor such that the turbine duct leading up to the first turbine rotor is generally annular in shape between an inner boundary defined by the conical housing 234 and an outer boundary defined by the surrounding walls of the duct 212. The conical housing has a conical shape which tapers from a base directly adjacent to the first turbine rotor at the leading side thereof to a respective apex 236 upstream from the first turbine rotor in a direction towards the inlet of the turbine duct against the wind direction 218. A plurality of spokes connecting between the surrounding walls of the duct and the conical housing may be provided to provide support to the conical housing relative to the surrounding duct 212. The housing 234 includes a hollow interior.

A booster motor 238 is mounted within the hollow interior of the conical housing 234 in the form of an electric motor driven to rotate with power generated from the electric generator 228, either transmitted directly from the generator or from an intermediate battery which is charged by the generator. The booster motor 238 includes a clutch 240 which is operable between an engaged position in which the booster motor 238 engages the first turbine rotor to drive rotation of the first turbine rotor and incorporated flywheel about the turbine rotor axis in addition to the wind forces driving rotation thereof, and a disengaged position in which the booster motor is disengaged from the first turbine rotor 220 and incorporated flywheel.

The clutch 240 includes a first clutch plate 242 mounted coaxially with the turbine rotor axis at the leading side of the first turbine rotor 220 for rotation together with the turbine rotor and flywheel, and a second clutch plate 244 mounted on an output of the booster motor 238 for being driven to rotate by the booster motor as an output of the motor.

The booster motor 238 is mounted for longitudinal sliding movement on a rail 246 in the direction of the turbine rotor axis between the engaged position of the clutch in which the first and second clutch plates engage one another for operatively connecting the booster motor to the first turbine rotor and associated flywheel and the disengaged position of the clutch in which the first and second clutch plates are disengaged from one another for operatively disconnecting the booster motor from the first turbine rotor and associated flywheel.

A suitable linear actuator 248, for example a hydraulic or pneumatic piston and cylinder assembly coupled between the rail 246 and the booster motor can be used for displacing the booster motor and second clutch plate supported thereon relative to the first clutch plate. The rail 246 remains fixed relative to the surrounding conical housing 234 and in turn the surrounding duct 212.

The wind turbine assembly 210 further includes a booster fan 250 coupled to communicate with the turbine duct 212 upstream from the turbine rotors, between the inlet end of the duct and the turbine rotors. The booster fan 250 provides a supplementary flow of air into the turbine duct 212 when actuated. The booster fan is driven to rotate by a respective electric drive motor which also is driven by electric power received from the electric generator 228, either directly or through an intermediate battery charged by the generator.

Under normal operating conditions, with sufficient wind forces, the booster motor and booster fan remain inactive and inoperative. The wind turbine assembly is arranged to determine a low wind condition when I) the measured wind speed in the turbine duct upstream from the turbine rotors falls below a prescribed lower limit, or ii) the measured speed of rotation of one or both turbine rotors and incorporated flywheels falls below a prescribed lower limit, or iii) any other suitable sensing means indicative of low wind, or iv) any combination of the above.

In response to the determination of a low wind condition, a controller of the wind turbine assembly is arranged to automatically actuate either one or both of the booster motor and the booster fan. In the event of the booster motor being actuated, the booster motor serves to maintain the speed of rotation of the turbine rotor flywheel above a prescribed minimum rotation speed to ensure a minimum power generating capacity of the electric generator is met. Typically, one or both of the booster motor or booster fan are operated intermittently in small bursts to maintain flywheel rotation speed.

As described herein with regard to FIGS. 15 and 16 an electric motor 238 is mounted in the rotor hub on a rail which is connected to a rotating contact disk 244 also contained in the rotor hub. This rotating contact disk #1 will be located next to a similar rotating contact disk 242 mounted on the turbine rotor. The two disks in their inactive position are separated apart by a distance of approximately 1 mm.

When the wind slows down or stops, sensors will activate the motor in the rotor hub to turn the rotating contact disk 242 at a high speed and push pull pneumatic pistons (one forward and one back) will engage the disk forward to contact the turbine rotor contact rotor disk 244 and act to turn the turbine rotor/flywheel faster for a few seconds then retract back by the action of the pneumatic piston.

This sequence will repeat in a cycle giving the turbine rotor/flywheel intermittent boosts to its speed to be able to keep generating electricity.

In one exemplary embodiment, the speed of the turbine rotor flywheel will be rated to produce 1 MW more than its listed output such that when the backup system(s) are in operation this 1 MW will be used to power the backup system while maintaining its listed power generating capacity. For example: a unit listed to generate 8 MW will actually generate 9 MW so that when conditions of low or no winds are present the backup system will utilize 1 MW of power to run the motor (or the fans of the other backup system) and the unit will continue to produce its listed output of 8 MW.

This backup system is in addition to another backup system using fans and may be used on its own or with the other system. When sufficient winds resume, sensors will inactivate this backup system and wind will then take over to supply the force necessary to rotate the turbine rotor blades.

Each turbine rotor doubles as a flywheel and can be used either singly or in combination and where electricity production stored above a certain limit such as 8 MW can be siphoned off or reallocated to intermittently power the small electric motor with a double clutch system to boost the rotation of the turbine or 2 turbines back to back. Sensors will activate the system at determined points such that the generator will maintain a level of output (8 MW) for a period of time.

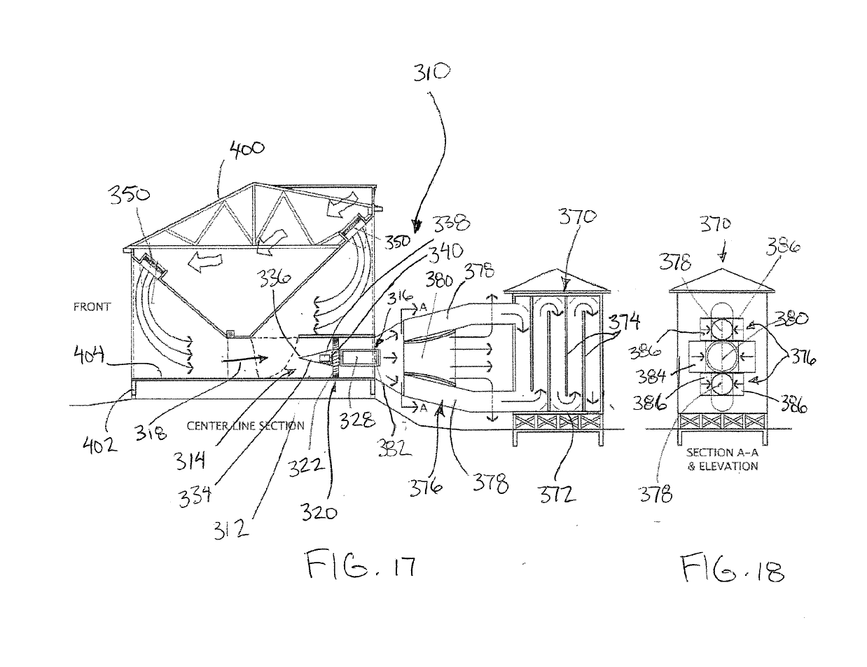

Turning now to FIGS. 17 and 18, there is illustrated a further embodiment of the wind turbine assembly generally indicated by reference numeral 310. The assembly 310 in this instance includes a turbine duct 312 which extends in a longitudinal direction between an inlet end 314 and an outlet end 316 for receiving a flow of wind therethrough generally in a wind direction 318.

A turbine rotor 320 is rotatably supported within the turbine duct for rotation about a turbine rotor axis oriented in the longitudinal direction of the duct. The rotor 320 fully spans the cross sectional area of the turbine duct and includes a plurality of blades 322 arranged to drive rotation of the turbine rotor responsive to wind forces from the flow of wind through the turbine duct in the wind direction.

In addition to the blades 322, the turbine rotor 320 is configured as a flywheel, for example by providing a peripheral mass which extends circumferentially about the perimeter of the blades 322 for rotation together with the rotor relative to the duct. For example, the turbine rotor may be constructed such that the blades are lighter towards a center of the turbine and most of the mass of the turbine is located at the periphery by additional weighted flywheel masses or by arranging the blades to have a greater mass towards the outer periphery of the rotor.

An electric generator 328 is mounted within the turbine duct downstream of the rotor 320. The generator is coupled to rotate together with the turbine rotor rotation such that the generator produces electrical power in response to turbine rotation from wind forces through the turbine duct.

Optionally a second turbine rotor may be mounted downstream from the generator in connection with the generator for commonly driving the generator with the first turbine rotor.

A conical housing 334 is mounted upstream of the first turbine rotor directly adjacent the hub of the turbine rotor such that the turbine duct leading up to the first turbine rotor is generally annular in shape between an inner boundary defined by the conical housing 334 and an outer boundary defined by the surrounding walls of the duct 312. The conical housing has a conical shape which tapers from a base directly adjacent to the first turbine rotor 320 at the leading side thereof to a respective apex 36 upstream from the first turbine rotor in a direction towards the inlet of the turbine duct against the wind direction 318. A plurality of spokes connecting between the surrounding walls of the duct and the conical housing may be provided to provide support to the conical housing relative to the surrounding duct 312. The housing 334 includes a hollow interior.

A booster motor 338 is mounted within the hollow interior of the conical housing 334 in the form of an electric motor driven to rotate with power generated from the electric generator 328, either transmitted directly from the generator or from an intermediate battery which is charged by the generator. Booster motor 338 includes a clutch which is operable between an engaged position in which the booster motor 338 engages the first turbine rotor to drive rotation of the first turbine rotor and incorporated flywheel about the turbine rotor axis in addition to the wind forces driving rotation thereof, and a disengaged position in which the booster motor is disengaged from the first turbine rotor and incorporated flywheel.

The wind turbine assembly 310 further includes a booster fan 350 coupled to communicate with the turbine duct 312 upstream from the turbine rotors, between the inlet end of the duct and the turbine rotors. The booster 350 provides a supplementary flow of air into the turbine duct when actuated. The booster fan is driven to rotate by a respective electric drive motor which is also driven by electric power received from the electric generator 328, either directly or through an intermediate battery charged by the generator.

Under normal operating conditions, with sufficient wind forces, the booster motor and booster fan remain inactive and inoperative. The wind turbine assembly is arranged to determine a low wind condition when i) the measured wind speed in the turbine duct upstream from the turbine rotors falls below a prescribed lower limit, or, ii) the measured speed of rotation of one or both turbine rotors and incorporated flywheels falls below a prescribed lower limit, or iii) any other suitable sensing means indicative of low wind, or iv) any combination of the above.

In response to a determination available wind condition, a controller of the wind turbine assembly is arranged to automatically actuate either one or both of the booster motor and the booster fan. In the event of the booster motor being actuated, the booster motor serves to maintain the speed of rotation of the turbine rotor flywheel above a prescribed minimum rotation speed to ensure a minimum power generating capacity of the electric generator is met. Typically, one or both of the booster motor or booster fan are operated intermittently in small bursts to maintain flywheel rotation speed.

In addition to the mechanisms above for maintaining speed of rotation of the turbine rotor above a prescribed minimum rotation speed, the controller may also reconfigure the exhaust from the outlet of the turbine duct 312, to boost turbine efficiency by reducing outlet back pressure under low wind conditions.

Under normal operation, the discharge flow of air exhausted from the outlet of the turbine duct is directed to a sound attenuation device 370. The sound attenuation device comprises a housing 372 supporting a plurality of baffles 374 therein which defines a sinuous flow path for receiving the discharge flow of air from the turbine outlet therethrough in a manner which attenuates sound in the discharge flow.

A primary exhaust duct 376 is provided in the form of a plurality of primary passages 78 which collectively define the primary exhaust duct 376 for communicating from the duct outlet of the turbine duct to the inlet of the sound attenuating device.

A secondary exhaust duct 380 is aligned concentrically with the outlet of the turbine duct at an inlet end for communication from the outlet of the turbine duct to the surrounding atmosphere. The outlet end of the secondary exhaust duct includes a plurality of laterally oriented outlet passages which are vented externally to the atmosphere towards laterally opposing sides of the secondary exhaust duct.

The secondary exhaust duct includes a diverging duct section in which a cross sectional area of the secondary exhaust duct increases in a downstream direction away from the duct outlet of the turbine duct so as to be arranged to boost power generated by the turbine when the discharge flow of air from the turbine duct outlet is directed through the diverging duct section.

The primary exhaust duct specifically includes two primary passages is 378 located at diametrically opposed to the top and bottom sides of the secondary exhaust duct 380. A manifold section 382 collectively communicates from the outlet of the turbine duct 312 to the inlet of the secondary passages 378 of the primary duct and the singular passage of the secondary duct 380 therebetween.

A secondary door assembly comprised of two secondary doors 384 is mounted at the communication between the manifold section 382 and the inlet of the secondary exhaust duct 380. The two doors 384 are mounted in a common plane oriented perpendicularly to the longitudinal flow direction through the secondary duct. The two doors are slidable within a respective plane of the doors from diametrically opposed sides of the secondary duct to be movable in a lateral direction between an open position in which the doors are spaced apart and the secondary duct is unobstructed by the doors 384 for directing the discharge flow of air to atmosphere, and a closed position in which the two secondary doors 384 abut one another to fully close the secondary exhaust duct and prevent flow of discharge air therethrough.

Similarly, each primary passage 378 of the primary duct 376 is provided with a pair of primary doors 386 at the communication between the manifold section 382 and the inlet of the primary passages. The two primary doors 386 of each primary passage are mounted in a common plane oriented perpendicularly to the longitudinal flow direction through the primary passages. The two doors 386 are slidable within a respective plane of the doors from diametrically opposed sides of the primary passage to be movable in a lateral direction between an open position in which the doors are spaced apart and the primary passage is unobstructed by the doors for directing the discharge flow of air therethrough to the sound attenuation device, and a closed position in which the primary doors abut one another to fully close the primary passages and prevent flow of discharge air therethrough.

Under normal operating conditions, the secondary doors 384 are closed and the primary doors 386 are opened to direct all discharge flow from the outlet of the turbine to the sound attenuating device. The controller is coupled to suitable actuators which operate the doors between the open and closed positions thereof. Accordingly, upon determination of a first low wind condition, the controller can open the secondary doors and close the primary doors so that discharge air is vented directly to atmosphere through the diverging duct section 380 instead of through the sound attenuating device. This has the effect of reducing back pressure on the turbine to increase the operating efficiency of the turbine temporarily until a normal wind condition resumes.

Operation of the door assemblies from the normal operating mode to a low condition mode can be performed as a first response to a low wind condition before operation of the booster motor 338 or the booster fans 350. Alternatively, the door assemblies may be automatically switched to the low wind condition mode together with operation of either one or both of the booster motor 338 and the booster fan 350.

In one exemplary embodiment where it is intended to provide an overall electrical output for delivery to consumers at a target rate X, the turbine is designed to operate under normal wind conditions so as to provide electrical output at a surplus rate of X plus Y. Accordingly, under normal wind conditions, the surplus electrical output Y can be stored in batteries or as kinetic energy within the turbine flywheel. The surplus Y can then be used to activate the booster motor, or the fan when the wind slows down or stops momentarily. By reconfiguring the discharge of exhaust air from the turbine outlet from the primary duct communicating with the sound attenuating device to the secondary duct vented to atmosphere, the efficiency of the turbine can be increased to maximize the amount that the surplus Y can be used to keep the turbine flywheel functioning until the wind conditions return to normal.

The components of the turbine assembly described above, including the turbine duct, the turbine rotor, the booster motor, and the booster fans, are supported within a common housing 400 configured to resemble a residential building sized to receive occupants therein. The housing is supported on piles 402 which provide the function of a foundation such that a floor 404 of the housing is supported spaced above an upper surface of the ground beneath the housing. The housing is supported in sufficiently close proximity to the ground to provide the appearance of a building supported at ground level, however, the clearance gap provided beneath the housing as a result of the piles allows for natural flows of ground surface water to pass beneath the housing and not interfere with the function of the housing.

Since various modifications can be made in my invention as herein above described, and many apparently widely different embodiments of same made, it is intended that all matter contained in the accompanying specification shall be interpreted as illustrative only and not in a limiting sense.

1. A wind turbine assembly comprising:
a main building structure substantially at ground level comprising a plurality of upright perimeter walls and a roof spanning over the perimeter walls;
at least one wind turbine supported within the building structure which includes a turbine duct communicating from a turbine inlet to a turbine outlet which is exhausted externally of the main building structure, and a turbine rotor which is rotatable within the turbine duct and which is arranged to be driven to rotate responsive to a flow of air through the turbine duct; and
at least one inlet duct supported with the building structure to communicate from an inlet opening in the perimeter walls of the building structure to an outlet in communication with the turbine inlet of said at least one turbine;
said at least one inlet duct tapering in height and width from the inlet opening in the perimeter walls to the turbine inlet of the turbine duct of said at least one turbine;
at least one canyon structure supported externally of the main building structure, said at least one canyon structure comprising upright channel walls extending generally radially from the main building structure near in height to the main building structure and a cover extending between the channel walls along at least a portion of the canyon structure so as to define an air channel between the walls extending generally radially from the main building structure between an open outer end and an inner end in communication with one or more of the inlet openings in the perimeters walls of the building structure.

2. The assembly according to claim 1 wherein said at least one canyon structure comprises a plurality of canyon structures extending in different radial directions from the main building structure.

3. The assembly according to claim 2 further comprising:
a plurality of the inlet ducts in the main building structure, each communicating with respective ones of the canyon structures; and
a plurality of gate members on the main building structure in association with respective inlet ducts of the main building structure, each gate member being operable between an open position allowing communication of the associated inlet duct with the respective canyon structures and a closed position in which the associated inlet duct is closed and prevented from communication with the respective canyon structures.

4. The assembly according to either one of claim 2 or 3 wherein the plurality of canyon structures are supported about a full circumference of the main building structure.

5. The assembly according to claim 5 wherein each canyon structure spans circumferentially relative to the main building structure between two adjacent ones of the channel walls which are oriented at approximately 30 degrees relative to one another.

6. The assembly according to any one of claims 1 through 5 wherein said at least one canyon structure includes an upright baffle wall oriented radially relative to the main building structure and spanning a height of the air channel at an intermediate location between the upright channel walls of the canyon structure so as to extend partway along a length of the canyon structure from the outer end towards the main building structure.

7. The assembly according to any one of claims 1 through 6 wherein said at least one canyon structure further comprises a plurality of flexible members extending under tension between the upright channel walls of the canyon structure.

8. The assembly according to any one of claims 1 through 7 wherein a top of the air channel between the upright channel walls of said at least one canyon structure is only partially covered by the cover such that a portion of the top of the air channel remains open to accept air flow therethrough into the air channel.

9. The assembly according to any one of claims 1 through 8 wherein the cover of said at least one canyon structure is substantially parallel to ground level.

10. The assembly according to any one of claims 1 through 9 wherein the cover of said at least one canyon structure is formed of flexible material spanning under tension between the upright channel walls of said at least one canyon structure.

11. The assembly according to any one of claims 1 through 10 wherein the cover of said at least one canyon structure includes a plurality of main cover portions lying in a generally common plane and a plurality of inlet cover portions which extend radially inwardly towards the main building structure at a downward slope into the air channel relative to the generally common plane.

12. The assembly according to any one of claims 1 through 11 wherein the cover of said at least one canyon structure includes a plurality of main cover portions lying in a generally common plane, a plurality of inlet apertures in the main cover portions, and a plurality of intake members in association with the inlet apertures respectively so as to extend radially outwardly away from the main building structure at an upward slope away from the generally common plane of the air channel.

13. The assembly according to any one of claims 1 through 12 further comprising:
said at least one canyon structure comprising a plurality of canyon structures extending in different radial directions from the main building structure;
said at least one turbine being centrally located in the main building structure; and
said at least one inlet duct comprising a plurality of inlet ducts in the main building structure, each communicating between respective ones of the canyon structures and the centrally located at least one turbine.

14. The assembly according to claim 13 wherein said at least one turbine is exhausted upwardly through a common exhaust duct which is exhausted through the roof of the main building structure.

15. The assembly according to claim 14 wherein the common exhaust duct is exhausted externally of the building through covered roof vents which are exhausted laterally.

16. The assembly according to any one of claims 13 through 15 wherein said at least one turbine drives rotation of a common drive shaft which turns rotation of an electric generator supported in the main building structure below said at least one turbine.

17. The assembly according to any one of claims 13 through 16 wherein said at least one turbine comprises a plurality of turbines associated with respective ones of the plurality of inlet ducts.

18. The assembly according to any one of claims 13 through 16 wherein said at least one inlet duct comprises a single turbine associated with all of the plurality of inlet ducts.

19. The assembly according to claim 18 further comprising a movable transition duct portion which is associated with each inlet duct which is movable between an active state forming a portion of a transition duct between the respective inlet duct and the turbine inlet of said single turbine while closing communication between other ones of the inlet ducts with the turbine inlet of said single turbine, and an inactive state in which the associated inlet duct is closed from communicating with turbine inlet of said single turbine by other ones of the transition duct portions.

20. The assembly according to any one of claims 1 through 19 further comprising a booster motor operatively connected to the flywheel so as to be arranged to drive rotation of the flywheel supplementary to the wind forces responsive to a low wind condition in which the wind forces are reduced relative to a normal wind condition.

21. The assembly according to claim 20 wherein the low wind condition is determined when a measured wind speed of the flow of wind through the turbine duct falls below a prescribed lower limit.

22. The assembly according to claim 20 wherein the low wind condition is determined when a measured rotation speed of the flywheel falls below a prescribed lower limit.

23. The assembly according to any one of claims 20 through 22 further comprising a clutch arranged to operatively disconnect the booster motor from the flywheel during the normal wind condition and operatively connect the booster motor to the flywheel during the low wind condition.

24. The assembly according to any one of claims 1 through 19 further comprising:
a sound attenuating device for receiving a discharge flow of air being exhausted from the main building structure therethrough so as to attenuate sound in the discharge flow;
a primary exhaust duct communicating between the turbine outlet of the turbine duct of said at least one turbine and the sound attenuating device;
a primary door assembly operatively connected to the primary exhaust duct so as to be operable between a closed position preventing communication between the turbine duct of said at least one turbine and the sound attenuating device through the primary exhaust duct, and an open position in which the primary exhaust duct is substantially unobstructed by the primary door assembly;
a secondary exhaust duct communicating from the turbine outlet of the turbine duct of said at least one turbine externally to atmosphere;
a secondary door assembly operatively connected to the secondary exhaust duct so as to be operable between a closed position preventing communication between the turbine duct of said at least one turbine to the atmosphere through the secondary exhaust duct, and an open position in which the secondary exhaust duct is substantially unobstructed by the secondary door assembly.

25. The assembly according to claim 24 wherein the secondary exhaust duct includes a diverging duct section in which a cross sectional area of the secondary exhaust duct increases in a downstream direction away from the duct outlet of the turbine duct so as to be arranged to boost power generated by the turbine in the second mode of operation relative to the first mode of operation.

26. The turbine assembly according to either one of claim 24 or 25 wherein the first mode of operation corresponds to a normal wind condition and wherein the second mode of operation corresponds to a low wind condition and wherein the low wind condition is determined when a measured wind speed of the flow of wind through the turbine duct falls below a prescribed lower limit.

27. The turbine assembly according to either one of claim 24 or 25 wherein the first mode of operation corresponds to a normal wind condition and wherein the second mode of operation corresponds to a low wind condition and wherein the low wind condition is determined when a measured rotation speed of the turbine falls below a prescribed lower limit.

28. A wind turbine assembly comprising:
a turbine duct arranged to receive a flow of wind therethrough in a longitudinal direction of the duct;
a turbine rotor supported within the turbine duct for rotation about a turbine rotor axis so as to be arranged to be rotated responsive to wind forces from said flow of wind through the turbine duct;
a flywheel operatively connected to the turbine rotor so as to be arranged to rotate together with the rotation of the turbine;
an electric generator operatively connected to the flywheel so as to be arranged to generate electricity responsive to rotation of the flywheel;
a booster motor operatively connected to the flywheel so as to be arranged to drive rotation of the flywheel supplementary to the wind forces responsive to a low wind condition in which the wind forces are reduced relative to a normal wind condition.

29. The assembly according to claim 28 wherein the low wind condition is determined when a measured wind speed of the flow of wind through the turbine duct falls below a prescribed lower limit.

30. The assembly according to claim 28 wherein the low wind condition is determined when a measured rotation speed of the flywheel falls below a prescribed lower limit.

31. The assembly according to any one of claims 28 through 30 further comprising a clutch arranged to operatively disconnect the booster motor from the flywheel during the normal wind condition and operatively connect the booster motor to the flywheel during the low wind condition.

32. The assembly according to any one of claims 28 through 31 wherein the booster motor is supported within a hub at the turbine rotor axis.

33. The assembly according to claim 32 further comprising a clutch arranged to operatively disconnect the booster motor from the flywheel during the normal wind condition in a disengaged position and operatively connect the booster motor to the flywheel during the low wind condition in an engaged position, the clutch comprising a first clutch plate rotatable with the flywheel and a second clutch plate rotatable with an output of the booster motor in which the first and second clutch plates are axially movable relative to one another between the engaged and disengaged positions of the clutch.

34. The assembly according to any one of claims 28 through 33 wherein the flywheel is incorporated into the turbine rotor as a unitary member rotatable about the turbine rotor axis.

35. The assembly according to any one of claims 28 through 34 further comprising an auxiliary rotor supported within the turbine duct for rotation about the turbine rotor axis so as to be arranged to be rotated responsive to wind forces from said flow of wind through the turbine duct.

36. The assembly according to claim 35 further comprising an auxiliary flywheel incorporated into the auxiliary rotor as a unitary member rotatable about the turbine rotor axis.

37. The assembly according to either one of claim 35 or 36 wherein the electric generator comprises a first generator driven to rotate by the turbine rotor and a second generator driven to rotate by the auxiliary rotor independently of the first generator.

38. The assembly according to any one of claims 28 through 37 further comprising a booster fan arranged to provide a supplementary flow of air through the turbine duct in response to the low wind condition in addition to operation of the booster motor.

39. The assembly according to any one of claims 28 through 37 further comprising a booster fan arranged to selectively provide a supplementary flow of air through the turbine duct in response to the low wind condition as an alternative to operation of the booster motor as selected by an operator.

40. A wind turbine assembly comprising:
a turbine duct extending in a longitudinal direction from a duct inlet to a duct outlet so as to be arranged to receive a flow of wind through the turbine duct in the longitudinal direction;
a turbine rotor supported within the turbine duct for rotation about a turbine rotor axis so as to be arranged to be rotated responsive to wind forces from said flow of wind through the turbine duct;
an electric generator operatively connected to turbine rotor so as to be arranged to generate electricity responsive to rotation of the rotor;
an auxiliary exhaust assembly for receiving a discharge flow of air therethrough from the duct outlet of the turbine duct;
a primary exhaust duct communicating between the duct outlet of the turbine duct and the auxiliary exhaust assembly;
a secondary exhaust duct communicating from the duct outlet of the turbine duct externally to atmosphere;
at least one door assembly operable in a first mode in which a majority of the discharge flow of air from the duct outlet of the turbine duct is directed through the primary exhaust duct and a second mode in which a majority of the discharge flow of air from the duct outlet of the turbine duct is directed through the secondary exhaust duct.

41. The assembly according to claim 40 wherein the secondary exhaust duct includes a diverging duct section in which a cross sectional area of the secondary exhaust duct increases in a downstream direction away from the duct outlet of the turbine duct so as to be arranged to boost power generated by the turbine in the second mode of operation relative to the first mode of operation.

42. The assembly according to either one of claim 40 or 41 wherein the turbine rotor is a flywheel.

43. The assembly according to any one of claims 40 through 42 wherein said at least one door assembly comprises:
a primary door assembly operatively connected to the primary exhaust duct so as to be operable between a closed position preventing communication between the turbine duct and the sound attenuating device through the primary exhaust duct, and an open position in which the primary exhaust duct is substantially unobstructed by the primary door assembly; and
a secondary door assembly operatively connected to the secondary exhaust duct so as to be operable between a closed position preventing communication between the turbine duct to the atmosphere through the secondary exhaust duct, and an open position in which the secondary exhaust duct is substantially unobstructed by the secondary door assembly.

44. The turbine assembly according to claim 43 including a controller adapted to open the primary door assembly and close the secondary door assembly when operating in a normal wind condition, and to close the primary door assembly and open the secondary door assembly when operating in a low wind condition in which wind forces are reduced relative to the normal wind condition.

45. The turbine assembly according to any one of claims 40 through 44 wherein the first mode of operation corresponds to a normal wind condition and wherein the second mode of operation corresponds to a low wind condition and wherein the low wind condition is determined when a measured wind speed of the flow of wind through the turbine duct falls below a prescribed lower limit.

46. The turbine assembly according to any one of claims 40 through 44 wherein the first mode of operation corresponds to a normal wind condition and wherein the second mode of operation corresponds to a low wind condition and wherein the low wind condition is determined when a measured rotation speed of the turbine falls below a prescribed lower limit.

47. The turbine assembly according to claim 46 further comprising a booster motor operatively connected to the turbine rotor so as to be arranged to drive rotation of the turbine rotor supplementary to the wind forces responsive to the low wind condition.

48. The turbine assembly according to claim 46 further comprising a booster fan arranged to provide a flow of air through the turbine duct responsive to the low wind condition.

49. The turbine assembly according to any one of claims 40 through 48 wherein the auxiliary exhaust assembly comprises a sound attenuating device adapted to attenuate sound in the discharge flow.

50. The turbine assembly according to claim 49 wherein the sound attenuating device comprises baffles located within the auxiliary exhaust assembly which define a sinuous path through the auxiliary exhaust assembly receiving the discharge flow of air therethrough.

51. The turbine assembly according to any one of claims 40 through 50 wherein the secondary exhaust duct is concentric with the duct outlet of the turbine duct.

52. The turbine assembly according to any one of claims 40 through 51 wherein the primary exhaust duct comprises a plurality of primary passages arranged at circumferentially spaced positions about the secondary exhaust duct.

53. The turbine assembly according to any one of claims 43 through 52 wherein the secondary door assembly comprises at least one sliding door movable within a plane of the sliding door between the open and closed positions thereof.

54. The turbine assembly according to claim 14 wherein the secondary door assembly comprises two diametrically opposed sliding doors.

55. The turbine assembly according to any one of claims 43 through 54 wherein the primary exhaust duct comprises at least one primary passage and wherein the primary door assembly comprises at least one sliding door movable within a plane of the sliding door relative to said at least one primary passage between the open and closed positions thereof.

56. The turbine assembly according to any one of claims 40 through 55, wherein the turbine duct, the turbine rotor, and the generator are supported within a common housing supported on piles such that a bottom floor of the housing is space above an upper surface of the ground between the housing.

57. The turbine assembly according to claim 56 wherein the housing is configured to resemble a building sized to receive occupants therein.

58. A wind turbine assembly comprising:
a turbine duct extending in a longitudinal direction from a duct inlet to a duct outlet so as to be arranged to receive a flow of wind through the turbine duct in the longitudinal direction;
a turbine rotor supported within the turbine duct for rotation about a turbine rotor axis so as to be arranged to be rotated responsive to wind forces from said flow of wind through the turbine duct;
an electric generator operatively connected to turbine rotor so as to be arranged to generate electricity responsive to rotation of the rotor;
a sound attenuating device for receiving a discharge flow of air therethrough so as to attenuate sound in the discharge flow;
a primary exhaust duct communicating between the duct outlet of the turbine duct and the sound attenuating device;
a primary door assembly operatively connected to the primary exhaust duct so as to be operable between a closed position preventing communication between the turbine duct and the sound attenuating device through the primary exhaust duct, and an open position in which the primary exhaust duct is substantially unobstructed by the primary door assembly;
a secondary exhaust duct communicating from the duct outlet of the turbine duct externally to atmosphere;
a secondary door assembly operatively connected to the secondary exhaust duct so as to be operable between a closed position preventing communication between the turbine duct to the atmosphere through the secondary exhaust duct, and an open position in which the secondary exhaust duct is substantially unobstructed by the secondary door assembly.
